(19) United States
(12) Patent Application Publication
(10) Pub. No.: US 2008/0015292 A1
(43) Pub. Date: Jan. 17, 2008

(54) FLAME RETARDANT AND SCRATCH RESISTANT THERMOPLASTIC POLYCARBONATE COMPOSITIONS

(75) Inventors: Jan Pleun Lens, Breda (NL); Sriramakrishna Maruvada, Evansville, IN (US); Dake Shen, Shanghai (CN); Rajendra Kashinath Singh, Evansville, IN (US)

Correspondence Address: SABIC - LEXAN;SABIC Innovative Plastics - IP Legal, ONE PLASTICS AVE., PITTSFIELD, MA, 01201-3697, US

(73) Assignee: General Electric Company, Schenectady, NY (US)

(21) Appl. No.: 11/456,991

(22) Filed: Jul. 12, 2006

(51) Int. Cl. C08K 5/49

(52) U.S. Cl. 524/115

(57) ABSTRACT

A thermoplastic composition comprising in combination a dialkyl bisphenol polycarbonate homopolymer or copolymer comprising repeat carbonate units having the following structure;

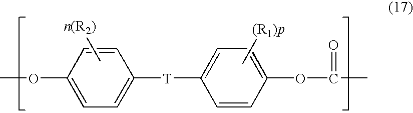

wherein R₁ and R₂ are independently at each occurrence a C₁-C₄ alkyl, n and p are each an integer having a value of 1 to 4, and T is selected from the group consisting of C₅-C₁₀ cycloalkanes attached to the aryl groups at one or two carbons, C₁-₅ alkyl groups, C₆-C₁₃ aryl groups, and C₇-C₁₂ aryl alkyl groups; a flame retardant; and an anti-dripping agent is disclosed. The compositions have excellent scratch resistance as well as an improved balance of physical properties such as melt flow, while at the same time maintaining their good flame performance.

### BACKGROUND

This invention is directed to flame retardant thermoplastic compositions comprising polycarbonate, their method of manufacture, and method of use thereof, and in particular thermoplastic polycarbonate compositions having improved scratch resistance.

Polycarbonates have been used in the manufacture of articles and components for a wide range of applications, from automotive parts to electronic appliances. Because of their broad use, particularly in electronic applications, it is desirable to provide polycarbonates with scratch resistance and flame retardancy. Many known flame retardant agents used with polycarbonates contain bromine and/or chlorine. Brominated and/or chlorinated flame retardant agents are less desirable because impurities and/or by-products arising from these agents can corrode the equipment associated with manufacture and use of the polycarbonates. Brominated and/or chlorinated flame retardant agents are also increasingly subject to regulatory restriction.

Nonbrominated and nonchlorinated flame retardants have been proposed for polycarbonates, including various fillers, phosphorus-containing compounds, and certain salts. It has been difficult to meet the strictest standards of flame retardancy using the foregoing flame retardants, however, without also using brominated and/or chlorinated flame retardants, particularly in thin walled samples.

With their strength and clarity, polycarbonate (PC) resins have a great many significant commercial applications. Unfortunately, polycarbonate resins are inherently not very flame resistant and hence, when burning, can drip hot molten material causing nearby substances to catch fire as well. Thus, in order to safely utilize polycarbonates in many commercial applications, it is necessary to include additives which further retard the flammability of the material and/or which reduce dripping.

A variety of different materials have been described for use in producing flame retardant (FR) and/or drip-resistant polycarbonates. Examples of these materials include those described in U.S. Pat. Nos. 3,971,756; 4,028,297; 4,110,299; 4,130,530; 4,303,575; 4,335,038; 4,552,911; 4,916,194; 5,218,027; and, 5,508,323.

Flame retardance additives utilized today typically include various sulfonate salts, phosphorous acid esters, brominated and/or chlorinated flame retardants, etc. However, the phosphate additives, which are used at relatively high loadings (i.e. greater than 5 percent, and around 10 percent to produce similar UL94 V0 performance), will deteriorate overall material mechanical performance. Additionally, brominated and chlorinated additives are prohibited by various Non-Government Organizations (NGO's) and environmental protection rules, such as Blue Angel, TCO'99, DIN/VDE, etc. Consequently, sulfonate salts are very widely used today as flame retardance additives.

Examples of sulfonate salt flame retardance additives include perfluoroalkane sulfonates, such as potassium perfluorobutane sulfonate (“KPFBS”, also known as “Rimar salt”). Another sulfonate salt flame retardance additive is, for example, potassium diphenylsulfone sulfonate (“KSS”).

In this regard, the use of perfluoroalkane sulfonates in polycarbonate resins is described in U.S. Pat. No. 3,775,367. Additionally, U.S. Pat. No. 6,353,046 discloses that improved flame retardance properties can be imparted to polycarbonate resin compositions by incorporating into the polycarbonate, potassium perfluorobutane sulfonate, and a cyclic siloxane, such as octaphenylcyclotetrasiloxane. U.S. Pat. No. 6,790,899 specifies the finding of a synergistic effect between KPFBS and sodium salt of toluene sulfonic acid (NaTS) on flame retardant polycarbonate compositions. Moreover, U.S. Patent Application 2005/0009968 teaches the synergistic effect between KPFBS and a number of inorganic sodium salts in transparent flame retardant carbonate compositions. Nevertheless, KPFBS contains fluorine and therefore is not Blue Angel conforming.

When thinner wall flame retardant performance is desired, a fluoro-containing anti-dripping additive may be utilized. However, to meet the Eco label requirements, only limited loading of the fluoro-containing anti-dripping additive can be used. For example, DIN/VDE requires a fluorine content of no more than 0.1 percent. However, the anti-dripping effect with this limited amount of fluoro-containing anti-dripping additive is generally poor. For example, when using a KSS/NaTS combination as the flame retardant package and TSAN as the anti-dripping additive at the DIN/VDE required loading, one cannot obtain a polycarbonate composition exhibiting a UL94 V0 @ 1.5 mm rating.

Furthermore, only limited flame retardance performance can be obtained when KSS is used alone. The conventional means for enhancing the flame retardancy properties while retaining transparency has been through the use of soluble organic halogen additives with KSS. For example, in some polycarbonate resin compositions, KSS with a loading of 0.3 to 0.5 phr is used with brominated polycarbonate. Without the bromine, those compositions have inconsistent and/or unreliable performance in the UL94 V0 @ 3.0 mm flammability test that these compositions are designed to meet.

While the foregoing flame retardants are suitable for their intended purposes, there nonetheless remains a continuing desire in the industry for continued improvement in flame performance while also providing good scratch resistance and maintaining other mechanical properties such as melt flow and HDT. Flame retardant polycarbonate blends have been used in a variety of applications such as computer and business equipment, battery chargers, industrial housings, and the like. There is a need for impact modified blends with high flow characteristics which are an attractive choice to mold large housings such as flat panel TV bezels as they offer a combination of interesting properties, including the capability to fill long flow lengths, adequate mechanical strength and flame retardancy. These impact modified blends also need to be free of chlorine and bromine flame retardant agents, but non-brominated and/or non-chlorinated flame retardants can adversely affect desirable physical properties of the polycarbonate compositions, particularly impact strength. While many parts made from impact modified blends have good mechanical properties, parts made from these blends typically suffer from poor scratch resistance due to the presence of the impact modifier. There is a need for flame retardant blends that provide good scratch resistance in combination with good mechanical properties, such as melt flow, and good flame performance.

There remains a continuing need in the art, therefore, for thermoplastic polycarbonate compositions having a combination of good physical properties, including melt flow and flame performance as well as scratch resistance, and in some cases, transparency.

### SUMMARY OF THE INVENTION

In one embodiment, a thermoplastic composition comprises in combination a dialkyl bisphenol polycarbonate homopolymer or copolymer comprising repeat carbonate units having the following structure;

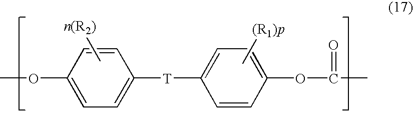

wherein R₁ and R₂ are independently at each occurrence a C₁-C₄ alkyl, n and p are each an integer having a value of 1 to 4, and T is selected from the group consisting of C₅-C₁₀ cycloalkanes attached to the aryl groups at one or two carbons, C₁-C₅ alkyl groups, C₆-C₁₃ aryl groups, and C₇-C₁₂ aryl alkyl groups; an aromatic polycarbonate; and a flame retardant; wherein the composition is capable of achieving a p(FTP) of at least 0.90 at a thickness of 3.0 mm.

In another embodiment, a thermoplastic composition comprises in combination a DMBPC homopolymer or copolymer having repeat units derived from the structure

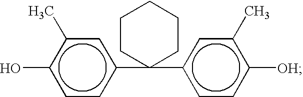

an aromatic polycarbonate; and a flame retardant; wherein the composition is capable of achieving a p(FTP) of at least 0.90 at a thickness of 3.0 mm.

In another embodiment, a thermoplastic composition comprises in combination a dialkyl bisphenol polycarbonate homopolymer or copolymer comprising repeat carbonate units having the following structure;

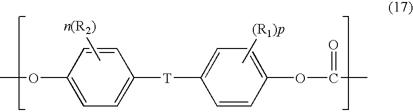

wherein R₁ and R₂ are independently at each occurrence a C₁-C₄ alkyl, n and p are each an integer having a value of 1 to 4, and T is selected from the group consisting of C₅-C₁₀ cycloalkanes attached to the aryl groups at one or two carbons, C₁-C₅ alkyl groups, C₆-C₁₃ aryl groups, and C₇-C₁₂ aryl alkyl groups; a flame retardant; and an anti-dripping agent, wherein the composition is capable of achieving a p(FTP) of at least 0.90 at a thickness of 2.0 mm.

In another embodiment, a thermoplastic composition comprises in combination a DMBPC homopolymer or copolymer having repeat units derived from the structure

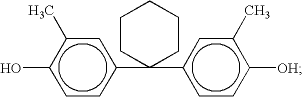

a flame retardant; and an anti-dripping agent, wherein the composition is capable of achieving a p(FTP) of at least 0.90 at a thickness of 2.0 mm.

In another embodiment, an article comprises the above thermoplastic composition.

In still another embodiment, a method of manufacture of an article comprises molding, extruding, or shaping the above thermoplastic composition.

### BRIEF DESCRIPTION OF THE FIGURE

FIG. 1 is a plot of the viscosity takeoff temperature vs. the percent DMBPC copolymer in the composition.

### DETAILED DESCRIPTION OF THE INVENTION

It has been discovered by the inventors hereof that use of a dialkyl bisphenol polycarbonate homopolymer or copolymer having a particular structure, a flame retardant and optionally an anti-dripping agent provides greatly improved balance of physical properties such as melt flow as well as scratch resistance to thermoplastic compositions containing polycarbonate, while at the same time maintaining their good flame performance and using lower amounts, or in some embodiments, none of the anti-dripping agent. The improvement in physical properties without significantly adversely affecting flame performance is particularly unexpected, especially with the lower levels of polytetrafluoroethylene (PTFE) or Teflon™ in the compositions, as the flame performance and physical properties of similar compositions without the dialkyl bisphenol polycarbonate can be significantly worse.

In some embodiments, the composition is transparent and has a haze level of less than 2.0%, and in some embodiments less than 1.0%. In some embodiments, the composition has a melt flow rate (MFR) of at least 20 g/10 min. The composition is capable of achieving a robust UL 94 V0 performance as indicated by p(FTP) of at least 0.90, optionally of at least 0.95 at a thickness of 3.0 mm, optionally at a thickness of 2.0 mm, optionally at a thickness of 1.5 mm, depending on the composition.

In an embodiment, a thermoplastic composition comprises in combination a dialkyl bisphenol polycarbonate homopolymer or copolymer comprising repeat carbonate units having the following structure;

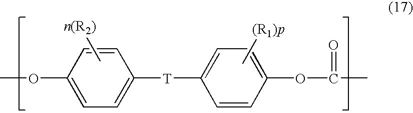

wherein R₁ and R₂ are independently at each occurrence a C₁-C₄ alkyl, n and p are each an integer having a value of 1 to 4, and T is selected from the group consisting of C₅-C₁₀ cycloalkanes attached to the aryl groups at one or two carbons, C₁-C₅ alkyl groups, C₆-C₁₃ aryl groups, and C₇-C₁₂ aryl alkyl groups; an aromatic polycarbonate; and a flame retardant; wherein the composition is capable of achieving a p(FTP) of at least 0.90 at a thickness of 3.0 mm, optionally a p(FTP) of at least 0.90 at a thickness of 2.0 mm.

In some embodiments, the polycarbonate homopolymer or copolymer comprising repeat carbonate units of formula (17) comprise a dialkyl bisphenol polycarbonate copolymer comprising repeat carbonate units having the following structure

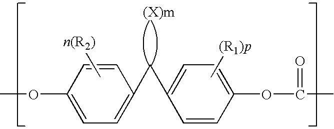

wherein R₁ and R₂ are independently selected from the group consisting of C₁ to C₆ alkyl; X represents CH₂; m is an integer from 4 to 7; n is an integer from 1 to 4; and p is an integer from 1 to 4, with the proviso that at least one of R₁ or R₂ is in the 3 or 3′ position. In other embodiments, the repeat units of the dialkyl bisphenol polycarbonate copolymer are derived from the structure

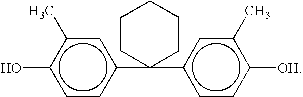

In some embodiments, the amount of repeat carbonate units of formula (17) in the composition is at least 5 wt. %.

In some embodiments, the flame retardant is a salt of a C₁₋₁₆ alkyl sulfonate, specifically a salt of a C₁₋₄ alkyl sulfonate.

In some embodiments, a molded article consisting of the thermoplastic composition has a haze value of 2.0% or less when measured according to ASTM D1003-00 on a 3.2 mm thick plaque, optionally 1.0% or less. In some embodiments, a molded article consisting of the thermoplastic composition has a transmission value of at least 85.0% when measured according to ASTM D1003-00 on a 3.2 mm thick plaque.

In another embodiment, a thermoplastic composition comprises in combination a DMBPC homopolymer or copolymer having repeat units derived from the structure

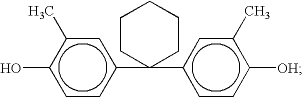

an aromatic polycarbonate; and a flame retardant; wherein the composition is capable of achieving a p(FTP) of at least 0.90 at a thickness of 3.0 mm.

In another embodiment, a thermoplastic composition comprises in combination a dialkyl bisphenol polycarbonate homopolymer or copolymer comprising repeat carbonate units having the following structure;

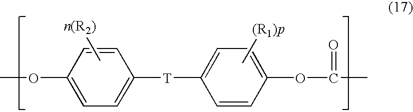

wherein R₁ and R₂ are independently at each occurrence a C₁-C₄ alkyl, n and p are each an integer having a value of 1 to 4, and T is selected from the group consisting of C₅-C₁₀ cycloalkanes attached to the aryl groups at one or two carbons, C₁-C₅ alkyl groups, C₆-C₁₃ aryl groups, and C₇-C₁₂ aryl alkyl groups; a flame retardant; and an anti-dripping agent, wherein the composition is capable of achieving a p(FTP) of at least 0.90 at a thickness of 2.0 mm. The composition optionally comprises a second polycarbonate.

In some embodiments, the composition is capable of achieving a p(FTP) of at least 0.90 at a thickness of 1.5 mm.

In some embodiments, an article is formed from the composition. In some embodiments, the article has a scratch resistance of HB or harder when measured according to the ASTM D3363-92a Pencil Hardness Test.

In another embodiment, a thermoplastic composition comprises in combination a DMBPC homopolymer or copolymer having repeat units derived from the structure

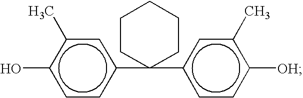

a flame retardant; and an anti-dripping agent, wherein the composition is capable of achieving a p(FTP) of at least 0.90 at a thickness of 2.0 mm.

As used herein, the term “polycarbonate” refers to a polymer comprising the same or different carbonate units, or a copolymer that comprises the same or different carbonate units, as well as one or more units other than carbonate (i.e. copolycarbonate); the term “aliphatic” refers to a hydrocarbon radical having a valence of at least one comprising a linear or branched array of carbon atoms which is not cyclic; “aromatic” refers to a radical having a valence of at least one comprising at least one aromatic group; “cycloaliphatic” refers to a radical having a valence of at least one comprising an array of carbon atoms which is cyclic but not aromatic; “alkyl” refers to a straight or branched chain monovalent hydrocarbon radical; “alkylene” refers to a straight or branched chain divalent hydrocarbon radical; “alkylidene” refers to a straight or branched chain divalent hydrocarbon radical, with both valences on a single common carbon atom; “alkenyl” refers to a straight or branched chain monovalent hydrocarbon radical having at least two carbons joined by a carbon-carbon double bond; “cycloalkyl” refers to a non-aromatic alicyclic monovalent hydrocarbon radical having at least three carbon atoms, with at least one degree of unsaturation; “cycloalkylene” refers to a non-aromatic alicyclic divalent hydrocarbon radical having at least three carbon atoms, with at least one degree of unsaturation; “aryl” refers to a monovalent aromatic benzene ring radical, or to an optionally substituted benzene ring system radical system fused to at least one optionally substituted benzene rings; “aromatic radical” refers to a radical having a valence of at least one comprising at least one aromatic group; examples of aromatic radicals include phenyl, pyridyl, furanyl, thienyl, naphthyl, and the like; “arylene” refers to a benzene ring diradical or to a benzene ring system diradical fused to at least one optionally substituted benzene ring; “alkylaryl” refers to an alkyl group as defined above substituted onto an aryl as defined above; “arylalkyl” refers to an aryl group as defined above substituted onto an alkyl as defined above; “alkoxy” refers to an alkyl group as defined above connected through an oxygen radical to an adjoining group; “aryloxy” refers to an aryl group as defined above connected through an oxygen radical to an adjoining group; and “direct bond”, where part of a structural variable specification, refers to the direct joining of the substituents preceding and succeeding the variable taken as a “direct bond”.

Compounds are described herein using standard nomenclature. For example, any position not substituted by any indicated group is understood to have its valency filled by a bond as indicated, or a hydrogen atom. A dash (“-”) that is not between two letters or symbols is used to indicate a point of attachment for a substituent. For example, —CHO is attached through the carbon of the carbonyl (C═O) group.

As used herein, the terms “polycarbonate” and “polycarbonate resin” means compositions having repeating structural carbonate units of formula (1):

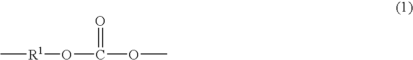

in which at least about 60 percent of the total number of R¹ groups are aromatic organic radicals and the balance thereof are aliphatic, alicyclic, or aromatic radicals. In one embodiment each R¹ is an aromatic organic radical and, more specifically, a radical of formula (2):

-A¹-Y¹-A²- (2)

wherein each of A¹ and A² is a monocyclic divalent aryl radical and Y¹ is a bridging radical having one or two atoms that separate A¹ from A². In an exemplary embodiment, one atom separates A¹ from A². Illustrative non-limiting examples of radicals of this type are —O—, —S—, —S(O)—, —S(O₂)—, —C(O)—, methylene, cyclohexylmethylene, 2-[2.2.1]-bicycloheptylidene, ethylidene, isopropylidene, neopentylidene, cyclohexylidene, cyclopentadecylidene, cyclododecylidene, and adamantylidene. The bridging radical Y¹ may be a hydrocarbon group or a saturated hydrocarbon group such as methylene, cyclohexylidene, or isopropylidene.

Polycarbonates may be produced by the interfacial reaction of dihydroxy compounds having the formula HO—R¹—OH, which includes dihydroxy compounds of formula (3)

HO-A¹-Y¹-A²-OH (3)

wherein Y¹, A¹ and A² are as described above. Also included are bisphenol compounds of general formula (4):

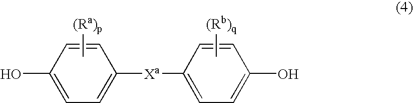

wherein R^{a} and R^{b} each represent a halogen atom or a monovalent hydrocarbon group and may be the same or different; p and q are each independently integers of 0 to 4; and X^{a} represents one of the groups of formula (5):

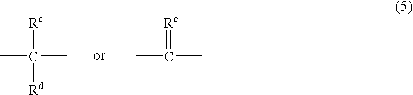

wherein R^{c} and R^{d} each independently represent a hydrogen atom or a monovalent linear or cyclic hydrocarbon group and R^{e} is a divalent hydrocarbon group.

Some illustrative, non-limiting examples of suitable dihydroxy compounds include the following: resorcinol, 4-bromoresorcinol, hydroquinone, 4,4′-dihydroxybiphenyl, 1,6-dihydroxynaphthalene, 2,6-dihydroxynaphthalene, bis(4-hydroxyphenyl)methane, bis(4-hydroxyphenyl)diphenylmethane, bis(4-hydroxyphenyl)-1-naphthylmethane, 1,2-bis(4-hydroxyphenyl)ethane, 1,1-bis(4-hydroxyphenyl)-1-phenylethane, 2-(4-hydroxyphenyl)-2-(3-hydroxyphenyl)propane, bis(4-hydroxyphenyl)phenylmethane, 2,2-bis(4-hydroxy-3-bromophenyl)propane, 1,1-bis(hydroxyphenyl)cyclopentane, 1,1-bis(4-hydroxyphenyl)cyclohexane, 1,1-bis(4-hydroxyphenyl)isobutene, 1,1-bis(4-hydroxyphenyl)cyclododecane, trans-2,3-bis(4-hydroxyphenyl)-2-butene, 2,2-bis(4-hydroxyphenyl)adamantine, (alpha, alpha′-bis(4-hydroxyphenyl)toluene, bis(4-hydroxyphenyl)acetonitrile, 2,2-bis(3-methyl-4-hydroxyphenyl)propane, 2,2-bis(3-ethyl-4-hydroxyphenyl)propane, 2,2-bis(3-n-propyl-4-hydroxyphenyl)propane, 2,2-bis(3-isopropyl-4-hydroxyphenyl)propane, 2,2-bis(3-sec-butyl-4-hydroxyphenyl)propane, 2,2-bis(3-t-butyl-4-hydroxyphenyl)propane, 2,2-bis(3-cyclohexyl-4-hydroxyphenyl)propane, 2,2-bis(3-allyl-4-hydroxyphenyl)propane, 2,2-bis(3-methoxy-4-hydroxyphenyl)propane, 2,2-bis(4-hydroxyphenyl)hexafluoropropane, 1,1-dichloro-2,2-bis(4-hydroxyphenyl)ethylene, 1,1-dibromo-2,2-bis(4-hydroxyphenyl)ethylene, 1,1-dichloro-2,2-bis(5-phenoxy-4-hydroxyphenyl)ethylene, 4,4′-dihydroxybenzophenone, 3,3-bis(4-hydroxyphenyl)-2-butanone, 1,6-bis(4-hydroxyphenyl)-1,6-hexanedione, ethylene glycol bis(4-hydroxyphenyl)ether, bis(4-hydroxyphenyl)ether, bis(4-hydroxyphenyl)sulfide, bis(4-hydroxyphenyl)sulfoxide, bis(4-hydroxyphenyl)sulfone, 9,9-bis(4-hydroxyphenyl)fluorine, 2,7-dihydroxypyrene, 6,6′-dihydroxy-3,3,3′,3′-tetramethylspiro(bis)indane (“spirobiindane bisphenol”), 3,3-bis(4-hydroxyphenyl)phthalide, 2,6-dihydroxydibenzo-p-dioxin, 2,6-dihydroxythianthrene, 2,7-dihydroxyphenoxathin, 2,7-dihydroxy-9,10-dimethylphenazine, 3,6-dihydroxydibenzofuran, 3,6-dihydroxydibenzothiophene, and 2,7-dihydroxycarbazole, and the like. Combinations comprising at least one of the foregoing dihydroxy compounds may also be used.

A nonexclusive list of specific examples of the types of bisphenol compounds that may be represented by formula (3) includes 1,1-bis(4-hydroxyphenyl) methane, 1,1-bis(4-hydroxyphenyl)ethane, 2,2-bis(4-hydroxyphenyl)propane (hereinafter “bisphenol A” or “BPA”), 2,2-bis(4-hydroxyphenyl)butane, 2,2-bis(4-hydroxyphenyl)octane, 1,1-bis(4-hydroxyphenyl)propane, 1,1-bis(4-hydroxyphenyl) n-butane, 2,2-bis(4-hydroxy-1-methylphenyl)propane, and 1,1-bis(4-hydroxy-t-butylphenyl)propane. Combinations comprising at least one of the foregoing bisphenol compounds may also be used.

Branched polycarbonates are also useful, as well as blends comprising a linear polycarbonate and a branched polycarbonate. The branched polycarbonates may be prepared by adding a branching agent during polymerization, for example a polyfunctional organic compound containing at least three functional groups selected from hydroxyl, carboxyl, carboxylic anhydride, haloformyl, and mixtures of the foregoing functional groups. Specific examples include trimellitic acid, trimellitic anhydride, trimellitic trichloride, tris-p-hydroxyphenylethane, isatin-bis-phenol, tris-phenol TC (1,3,5-tris((p-hydroxyphenyl)isopropyl)benzene), tris-phenol PA (4(4(1,1-bis(p-hydroxyphenyl)-ethyl) alpha, alpha-dimethyl benzyl)phenol), 4-chloroformyl phthalic anhydride, trimesic acid, and benzophenone tetracarboxylic acid. The branching agents may be added at a level of about 0.05 to 2.0 wt. %. All types of polycarbonate end groups are contemplated as being useful in the polycarbonate composition, provided that such end groups do not significantly affect desired properties of the thermoplastic compositions.

Suitable polycarbonates can be manufactured by processes such as interfacial polymerization and melt polymerization. Although the reaction conditions for interfacial polymerization may vary, an exemplary process generally involves dissolving or dispersing a dihydric phenol reactant in aqueous caustic soda or potash, adding the resulting mixture to a suitable water-immiscible solvent medium, and contacting the reactants with a carbonate precursor in the presence of a suitable catalyst such as triethylamine or a phase transfer catalyst, under controlled pH conditions, e.g., about 8 to about 10. The most commonly used water immiscible solvents include methylene chloride, 1,2-dichloroethane, chlorobenzene, toluene, and the like. Suitable carbonate precursors include, for example, a carbonyl halide such as carbonyl bromide or carbonyl chloride, or a haloformate such as a bishaloformates of a dihydric phenol (e.g., the bischloroformates of bisphenol A, hydroquinone, and the like) or a glycol (e.g., the bishaloformate of ethylene glycol, neopentyl glycol, polyethylene glycol, and the like). Combinations comprising at least one of the foregoing types of carbonate precursors may also be used.

Among the exemplary phase transfer catalysts that may be used are catalysts of the formula (R³)₄Q⁺X, wherein each R³ is the same or different, and is a C₁₋₁₀ alkyl group; Q is a nitrogen or phosphorus atom; and X is a halogen atom or a C₁₋₈ alkoxy group or C₆₋₁₈₈ aryloxy group. Suitable phase transfer catalysts include, for example, [CH₃(CH₂)₃]₄NX, [CH₃(CH₂)₃]₄PX, [CH₃(CH₂)₅]₄NX, [CH₃(CH₂)₆]₄NX, [CH₃(CH₂)₄]₄NX CH₃[CH₃(CH₂)₃]₃NX, and CH₃[CH₃(CH₂)₂]₃NX wherein X is Cl⁻, Br⁻, a C₁₋₈ alkoxy group or C₆₋₁₈ aryloxy group. An effective amount of a phase transfer catalyst may be about 0.1 to about 10 wt. % based on the weight of bisphenol in the phosgenation mixture. In another embodiment an effective amount of phase transfer catalyst may be about 0.5 to about 2 wt. % based on the weight of bisphenol in the phosgenation mixture.

Alternatively, melt processes may be used. Generally, in the melt polymerization process, polycarbonates may be prepared by co-reacting, in a molten state, the dihydroxy reactant(s) and a diaryl carbonate ester, such as diphenyl carbonate, in the presence of a transesterification catalyst. Volatile monohydric phenol is removed from the molten reactants by distillation and the polymer is isolated as a molten residue.

In an embodiment, the polycarbonate is a linear homopolymer derived from bisphenol A, in which each of A¹ and A² is p-phenylene and Y¹ is isopropylidene. The polycarbonates may have an intrinsic viscosity, as determined in chloroform at 25° C., of about 0.3 to about 1.5 deciliters per gram (dl/gm), specifically about 0.45 to about 1.0 dl/gm. The polycarbonates may have a weight average molecular weight of about 10,000 to about 200,000, specifically about 20,000 to about 100,000 as measured by gel permeation chromatography.

“Polycarbonate” and “polycarbonate resin” as used herein further includes copolymers comprising carbonate chain units together with a different type of chain unit. Such copolymers may be random copolymers, block copolymers, dendrimers and the like. One specific type of copolymer that may be used is a polyester carbonate, also known as a copolyester-polycarbonate. Such copolymers further contain, in addition to recurring carbonate chain units of the formula (1), repeating units of formula (6)

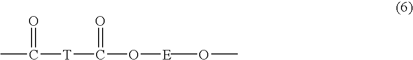

wherein E is a divalent radical derived from a dihydroxy compound, and may be, for example, a C₂₋₁₀ alkylene radical, a C₆₋₂₀ alicyclic radical, a C₆₋₂₀ aromatic radical or a polyoxyalkylene radical in which the alkylene groups contain 2 to about 6 carbon atoms, specifically 2, 3, or 4 carbon atoms; and T divalent radical derived from a dicarboxylic acid, and may be, for example, a C₂₋₁₀ alkylene radical, a C₆₋₂₀ alicyclic radical, a C₆₋₂₀ alkyl aromatic radical, or a C₆₋₂₀ aromatic radical.

In one embodiment, E is a C₂₋₆ alkylene radical. In another embodiment, E is derived from an aromatic dihydroxy compound of formula (7):

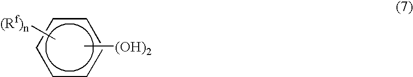

wherein each R^{f} is independently a halogen atom, a C₁₋₁₀ hydrocarbon group, or a C₁₋₁₀ halogen substituted hydrocarbon group, and n is 0 to 4. The halogen is preferably bromine. Examples of compounds that may be represented by the formula (7) include resorcinol, substituted resorcinol compounds such as 5-methyl resorcinol, 5-ethyl resorcinol, 5-propyl resorcinol, 5-butyl resorcinol, 5-t-butyl resorcinol, 5-phenyl resorcinol, 5-cumyl resorcinol, 2,4,5,6-tetrafluororesorcinol, 2,4,5,6-tetrabromo resorcinol, and the like; catechol; hydroquinone; substituted hydroquinones such as 2-methyl hydroquinone, 2-ethyl hydroquinone, 2-propyl hydroquinone, 2-butyl hydroquinone, 2-t-butyl hydroquinone, 2-phenyl hydroquinone, 2-cumyl hydroquinone, 2,3,5,6-tetramethyl hydroquinone, 2,3,5,6-tetra-t-butyl hydroquinone, 2,3,5,6-tetrafluorohydroquinone, 2,3,5,6-tetrabromo hydroquinone, and the like; or combinations comprising at least one of the foregoing compounds.

Examples of aromatic dicarboxylic acids that may be used to prepare the polyesters include isophthalic or terephthalic acid, 1,2-di(p-carboxyphenyl)ethane, 4,4′-dicarboxydiphenyl ether, 4,4′-bisbenzoic acid, and mixtures comprising at least one of the foregoing acids. Acids containing fused rings can also be present, such as in 1,4-, 1,5-, or 2,6-naphthalenedicarboxylic acids. Specific dicarboxylic acids are terephthalic acid, isophthalic acid, naphthalene dicarboxylic acid, cyclohexane dicarboxylic acid, or mixtures thereof. A specific dicarboxylic acid comprises a mixture of isophthalic acid and terephthalic acid wherein the weight ratio of terephthalic acid to isophthalic acid is about 10:1 to about 0.2:9.8. In another specific embodiment, E is a C₂₋₆ alkylene radical and T is p-phenylene, m-phenylene, naphthalene, a divalent cycloaliphatic radical, or a mixture thereof. This class of polyester includes the poly(alkylene terephthalates).

The copolyester-polycarbonate resins may have an intrinsic viscosity, as determined in chloroform at 25° C., of about 0.3 to about 1.5 deciliters per gram (dl/gm), specifically about 0.45 to about 1.0 dl/gm. The copolyester-polycarbonate resins may have a weight average molecular weight of about 10,000 to about 200,000, specifically about 20,000 to about 100,000 as measured by gel permeation chromatography.

The polycarbonate component may further comprise, in addition to the polycarbonates described above, combinations of the polycarbonates with other thermoplastic polymers, for example combinations of polycarbonate homopolymers and/or copolymers with polyesters and the like. As used herein, a “combination” is inclusive of all mixtures, blends, alloys, and the like. Suitable polyesters comprise repeating units of formula (6), and may be, for example, poly(alkylene dicarboxylates), liquid crystalline polyesters, and polyester copolymers. It is also possible to use a branched polyester in which a branching agent, for example, a glycol having three or more hydroxyl groups or a trifunctional or multifunctional carboxylic acid has been incorporated. Furthermore, it is sometime desirable to have various concentrations of acid and hydroxyl end groups on the polyester, depending on the ultimate end-use of the composition.

An example of suitable polyesters includes poly(alkylene terephthalates). Specific examples of suitable poly(alkylene terephthalates) are poly(ethylene terephthalate) (PET), poly(1,4-butylene terephthalate) (PBT), poly(ethylene naphthanoate) (PEN), poly(butylene naphthanoate), (PBN), (polypropylene terephthalate) (PPT), polycyclohexanedimethanol terephthalate (PCT), and combinations comprising at least one of the foregoing polyesters. Also contemplated herein are the above polyesters with a minor amount, that is, from about 0.5 to about 10 percent by weight, of units derived from an aliphatic diacid and/or an aliphatic polyol to make copolyesters.

The blends of a polycarbonate and a polyester may comprise about 10 to about 99 wt. % polycarbonate and correspondingly about 1 to about 90 wt. % polyester, in particular a poly(alkylene terephthalate). In one embodiment, the blend comprises about 30 to about 70 wt. % polycarbonate and correspondingly about 30 to about 70 wt. % polyester. The foregoing amounts are based on the combined weight of the polycarbonate and polyester.

Although blends of polycarbonates with other polymers are contemplated, in one embodiment the polycarbonate component consists essentially of polycarbonate, i.e., the polycarbonate component comprises polycarbonate homopolymers and/or polycarbonate copolymers, and no other resins that would significantly adversely impact the impact strength of the thermoplastic composition. In another embodiment, the polycarbonate component consists of polycarbonate, i.e., is composed of only polycarbonate homopolymers and/or polycarbonate copolymers.

The thermoplastic composition further comprises a polycarbonate homopolymer or copolymer comprising repeat carbonate units having the following structure (17):

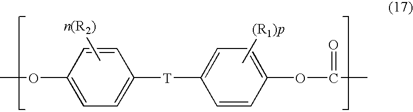

wherein R₁ and R₂ are independently at each occurrence a C₁-C₄ alkyl, n and p are each an integer having a value of 1 to 4, and T is selected from the group consisting of C₅-C₁₀ cycloalkanes attached to the aryl groups at one or two carbons, C₁-C₅ alkyl groups, C₆-C₁₃ aryl groups, and C₇-C₁₂ aryl alkyl groups.

In one embodiment, the structure of formula (17) comprises a dialkyl bisphenol repeat carbonate units having the following structure (18):

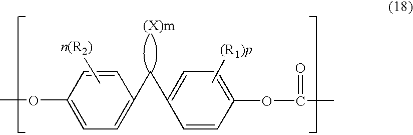

wherein R₁ and R₂ are independently selected from the group consisting of C₁ to C₆ alkyl; X represents CH₂; m is an integer from 4 to 7; n is an integer from 1 to 4; and p is an integer from 1 to 4, with the proviso that at least one of R₁ or R₂ is in the 3 or 3′ position. In some embodiments, R₁ and R₂ are C₁-C₃ alkyl, specifically CH₃.

In one embodiment, the dialkyl bisphenol polycarbonate comprises repeat units of DMBPC (dimethyl bisphenol cyclohexane or 1,1-bis(4-hydroxy-3-methylphenyl)cyclohexane) homopolymer or copolymer. The homopolymer of copolymer comprises DMBPC repeat units having the structure (19):

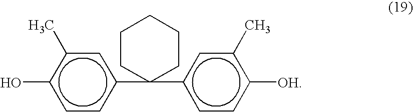

If a copolymer is desired, the DMBPC may be polymerized (or copolymerized) in polycarbonate. In an embodiment, DMBPC polycarbonate is used wherein the DMBPC comprises from 5 to 95 mol %, optionally from 20 to 80 mol %, optionally from 25 to 75 mol % DMBPC and from 95 to 5 mol %, optionally from 80 to 20 mol %, and optionally from 75 to 25 mol % bisphenol A.

The method of making the DMBPC polycarbonate is not particularly limited. It may be produced by any known method of producing polycarbonate including the well-known interfacial process using phosgene and/or the melt process using a diaryl carbonate, such as diphenyl carbonate or bis(o-methoxycarbonylphenyl)carbonate) (also known as bismethyl salicyl carbonate or BMSC), as the carbonate source.

As mentioned above, it is possible to incorporate another monomer into the polymer chain to make a copolymer comprising monomer units other than those derived from structures (17), (18) or (19). Other monomers are not limited and are suitably derived from a dihydroxy composition other than that of the above structure (17), (18) or (19). Examples of other monomers include, but are not limited to, aromatic dihydroxy compounds such as bisphenols, dihydroxy benzenes such as hydroquinone, resorcinol, methylhydroquinone, butylhydroquinone, phenylhydroquinone, 4-phenylresorcinol and 4-methylresorcinol, and dihydroxy compounds comprising aliphatic diols and/or acids. As previously mentioned, diacid chloride, dicarboxylic acid or diester monomers could also be included in DMBPC homopolymers or DMBPC-PC copolymers to provide a polyestercarbonate.

In one embodiment, the amount of dialkyl bisphenol polycarbonate component is at least 5 wt. %, specifically from 5 to 100 wt. %, based on the total weight of the polycarbonate component.

The thermoplastic composition optionally includes an impact modifier and/or an ungrafted rigid copolymer, with the proviso that the impact modifier and/or ungrafted rigid copolymer do not impact the desired properties of the composition. Suitable impact modifiers are typically high molecular weight elastomeric materials derived from olefins, monovinyl aromatic monomers, acrylic and methacrylic acids and their ester derivatives, as well as conjugated dienes. The polymers formed from conjugated dienes can be fully or partially hydrogenated. The elastomeric materials can be in the form of homopolymers or copolymers, including random, block, radial block, graft, and core-shell copolymers. Combinations of impact modifiers can be used.

A specific type of impact modifier is an elastomer-modified graft copolymer comprising (i) an elastomeric (i.e., rubbery) polymer substrate having a Tg less than 10° C., more specifically less than −10° C., or more specifically −40° to −80° C., and (ii) a rigid polymeric superstrate grafted to the elastomeric polymer substrate. Materials suitable for use as the elastomeric phase include, for example, conjugated diene rubbers, for example polybutadiene and polyisoprene; copolymers of a conjugated diene with less than 50 wt. % of a copolymerizable monomer, for example a monovinylic compound such as styrene, acrylonitrile, n-butyl acrylate, or ethyl acrylate; olefin rubbers such as ethylene propylene copolymers (EPR) or ethylene-propylene-diene monomer rubbers (EPDM); ethylene-vinyl acetate rubbers; silicone rubbers; elastomeric C₁₋₈ alkyl (meth)acrylates; elastomeric copolymers of C₁₋₈ alkyl (meth)acrylates with butadiene and/or styrene; or combinations comprising at least one of the foregoing elastomers. Materials suitable for use as the rigid phase include, for example, monovinyl aromatic monomers such as styrene and alpha-methyl styrene, and monovinylic monomers such as acrylonitrile, acrylic acid, methacrylic acid, and the C₁-C₆ esters of acrylic acid and methacrylic acid, specifically methyl methacrylate.

Specific exemplary elastomer-modified graft copolymers include those formed from styrene-butadiene-styrene (SBS), styrene-butadiene rubber (SBR), styrene-ethylene-butadiene-styrene (SEBS), ABS (acrylonitrile-butadiene-styrene), acrylonitrile-ethylene-propylene-diene-styrene (AES), styrene-isoprene-styrene (SIS), methyl methacrylate-butadiene-styrene (MBS), and styrene-acrylonitrile (SAN). Impact modifiers are generally present in amounts of 1 to 30 wt. %, based on the total weight of the composition.

Another example of a suitable impact modifier is a polycarbonate-polysiloxane copolymer. The polycarbonate-polysiloxane copolymer comprises polycarbonate blocks and polydiorganosiloxane blocks. The polycarbonate blocks in the copolymer comprise repeating structural units of formula (1) as described above, for example wherein R¹ is of formula (2) as described above. These units may be derived from reaction of dihydroxy compounds of formula (3) as described above. In one embodiment, the dihydroxy compound is bisphenol A, in which each of A¹ and A² is p-phenylene and Y¹ is isopropylidene.

The polydiorganosiloxane blocks comprise repeating structural units of formula (11) (sometimes referred to herein as ‘siloxane’):

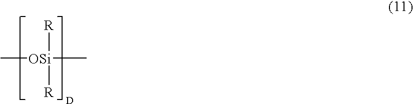

wherein each occurrence of R is same or different, and is a C₁₋₁₃ monovalent organic radical. For example, R may be a C₁-C₁₃ alkyl group, C₁-C₁₃ alkoxy group, C₂-C₁₃ alkenyl group, C₂-C₁₃ alkenyloxy group, C₃-C₆ cycloalkyl group, C₃-C₆ cycloalkoxy group, C₆-C₁₀ aryl group, C₆-C₁₀ aryloxy group, C₇-C₁₃ aralkyl group, C₇-C₁₃ aralkoxy group, C₇-C₁₃ alkaryl group, or C₇-C₁₃ alkaryloxy group. Combinations of the foregoing R groups may be used in the same copolymer.

The value of D in formula (11) may vary widely depending on the type and relative amount of each component in the thermoplastic composition, the desired properties of the composition, and like considerations. Generally, D may have an average value of 2 to about 1000, specifically about 2 to about 500, more specifically about 5 to about 100. In one embodiment, D has an average value of about 10 to about 75, and in still another embodiment, D has an average value of about 40 to about 60. Where D is of a lower value, for example, less than about 40, it may be desirable to use a relatively larger amount of the polycarbonate-polysiloxane copolymer. Conversely, where D is of a higher value, for example, greater than about 40, it may be necessary to use a relatively lower amount of the polycarbonate-polysiloxane copolymer.

A combination of a first and a second (or more) polycarbonate-polysiloxane copolymers may be used, wherein the average value of D of the first copolymer is less than the average value of D of the second copolymer.

In one embodiment, the polydiorganosiloxane blocks are provided by repeating structural units of formula (12):

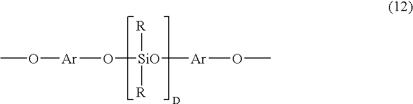

wherein D is as defined above; each R may be the same or different, and is as defined above; and Ar may be the same or different, and is a substituted or unsubstituted C₆-C₃₀ arylene radical, wherein the bonds are directly connected to an aromatic moiety. Suitable Ar groups in formula (12) may be derived from a C₆-C₃₀ dihydroxyarylene compound, for example a dihydroxyarylene compound of formula (3), (4), or (7) above. Combinations comprising at least one of the foregoing dihydroxyarylene compounds may also be used. Specific examples of suitable dihydroxyarlyene compounds are 1,1-bis(4-hydroxyphenyl)methane, 1,1-bis(4-hydroxyphenyl)ethane, 2,2-bis(4-hydroxyphenyl)propane, 2,2-bis(4-hydroxyphenyl)butane, 2,2-bis(4-hydroxyphenyl)octane, 1,1-bis(4-hydroxyphenyl)propane, 1,1-bis(4-hydroxyphenyl) n-butane, 2,2-bis(4-hydroxy-1-methylphenyl)propane, 1,1-bis(4-hydroxyphenyl)cyclohexane, bis(4-hydroxyphenyl sulphide), and 1,1-bis(4-hydroxy-t-butylphenyl)propane. Combinations comprising at least one of the foregoing dihydroxy compounds may also be used.

Such units may be derived from the corresponding dihydroxy compound of the following formula:

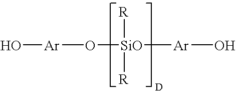

wherein Ar and D are as described above. Such compounds are further described in U.S. Pat. No. 4,746,701 Kress et al. Compounds of this formula may be obtained by the reaction of a dihydroxyarylene compound with, for example, an alpha, omega-bisacetoxypolydiorangonosiloxane under phase transfer conditions.

In another embodiment the polydiorganosiloxane blocks comprise repeating structural units of formula (13)

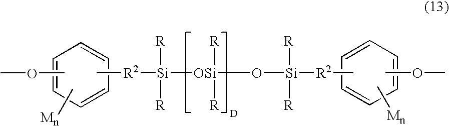

wherein R and D are as defined above. R² in formula (13) is a divalent C₂-C₈ aliphatic group. Each M in formula (13) may be the same or different, and may be a halogen, cyano, nitro, C₁-C₈ alkylthio, C₁-C₈ alkyl, C₁-C₈ alkoxy, C₂-C₈ alkenyl, C₂-C₈ alkenyloxy group, C₃-C₈ cycloalkyl, C₃-C₈ cycloalkoxy, C₆-C₁₀ aryl, C₆-C₁₀ aryloxy, C₇-C₁₂ aralkyl, C₇-C₁₂ aralkoxy, C₇-C₁₂ alkaryl, or C₇-C₁₂ alkaryloxy, wherein each n is independently 0, 1, 2, 3, or 4.

In one embodiment, M is bromo or chloro, an alkyl group such as methyl, ethyl, or propyl, an alkoxy group such as methoxy, ethoxy, or propoxy, or an aryl group such as phenyl, chlorophenyl, or tolyl; R² is a dimethylene, trimethylene or tetramethylene group; and R is a C₁₋₈ alkyl, haloalkyl such as trifluoropropyl, cyanoalkyl, or aryl such as phenyl, chlorophenyl or tolyl. In another embodiment, R is methyl, or a mixture of methyl and trifluoropropyl, or a mixture of methyl and phenyl. In still another embodiment, M is methoxy, n is one, R² is a divalent C₁-C₃ aliphatic group, and R is methyl.

These units may be derived from the corresponding dihydroxy polydiorganosiloxane (14):

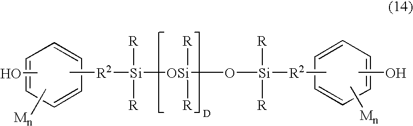

wherein R, D, M, R², and n are as described above.

Such dihydroxy polysiloxanes can be made by effecting a platinum catalyzed addition between a siloxane hydride of the formula (15),

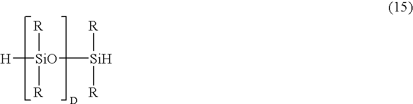

wherein R and D are as previously defined, and an aliphatically unsaturated monohydric phenol. Suitable aliphatically unsaturated monohydric phenols included, for example, eugenol, 2-alkylphenol, 4-allyl-2-methylphenol, 4-allyl-2-phenylphenol, 4-allyl-2-bromophenol, 4-allyl-2-t-butoxyphenol, 4-phenyl-2-phenylphenol, 2-methyl-4-propylphenol, 2-allyl-4,6-dimethylphenol, 2-allyl-4-bromo-6-methylphenol, 2-allyl-6-methoxy-4-methylphenol and 2-allyl-4,6-dimethylphenol. Mixtures comprising at least one of the foregoing may also be used.

The polycarbonate-polysiloxane copolymer may be manufactured by reaction of diphenolic polysiloxane (14) with a carbonate source and a dihydroxy aromatic compound of formula (3), optionally in the presence of a phase transfer catalyst as described above. Suitable conditions are similar to those useful in forming polycarbonates. For example, the copolymers are prepared by phosgenation, at temperatures from below 0° C. to about 100° C., specifically about 25° C. to about 50° C. Since the reaction is exothermic, the rate of phosgene addition may be used to control the reaction temperature. The amount of phosgene required will generally depend upon the amount of the dihydric reactants. Alternatively, the polycarbonate-polysiloxane copolymers may be prepared by co-reacting in a molten state, the dihydroxy monomers and a diaryl carbonate ester, such as diphenyl carbonate, in the presence of a transesterification catalyst as described above.

In the production of the polycarbonate-polysiloxane copolymer, the amount of dihydroxy polydiorganosiloxane is selected so as to provide the desired amount of polydiorganosiloxane units in the copolymer. The amount of polydiorganosiloxane units may vary widely, for example, may be about 1 wt. % to about 99 wt. % of polydimethylsiloxane, or an equivalent molar amount of another polydiorganosiloxane, with the balance being carbonate units. The particular amounts used will therefore be determined depending on desired physical properties of the thermoplastic composition, the value of D (within the range of 2 to about 1000), and the type and relative amount of each component in the thermoplastic composition, including the type and amount of polycarbonate, type and amount of impact modifier, type and amount of polycarbonate-polysiloxane copolymer, and type and amount of any other additives. Suitable amounts of dihydroxy polydiorganosiloxane can be determined by one of ordinary skill in the art without undue experimentation using the guidelines taught herein. For example, the amount of dihydroxy polydiorganosiloxane may be selected so as to produce a copolymer comprising about 1 wt. % to about 75 wt. %, or about 1 wt. % to about 50 wt. % polydimethylsiloxane, or an equivalent molar amount of another polydiorganosiloxane. In one embodiment, the copolymer comprises about 5 wt. % to about 40 wt. %, optionally about 5 wt. % to about 25 wt. % polydimethylsiloxane, or an equivalent molar amount of another polydiorganosiloxane, with the balance being polycarbonate. In a particular embodiment, the copolymer may comprise about 20 wt. % siloxane.

The polycarbonate-polysiloxane copolymers have a weight-average molecular weight (MW, measured, for example, by gel permeation chromatography, ultra-centrifugation, or light scattering) of about 10,000 g/mol to about 200,000 g/mol, specifically about 20,000 g/mol to about 100,000 g/mol.

The composition optionally further comprises an ungrafted rigid copolymer. The rigid copolymer is additional to any rigid copolymer present in the impact modifier. It may be the same as any of the rigid copolymers described above, without the elastomer modification. The rigid copolymers generally have a Tg greater than about 15° C., specifically greater than about 20° C., and include, for example, polymers derived from monovinylaromatic monomers containing condensed aromatic ring structures, such as vinyl naphthalene, vinyl anthracene and the like, or monomers of formula (9) as broadly described above, for example styrene and alpha-methyl styrene; monovinylic monomers such as itaconic acid, acrylamide, N-substituted acrylamide or methacrylamide, maleic anhydride, maleimide, N-alkyl, aryl or haloaryl substituted maleimide, glycidyl (meth)acrylates, and monomers of the general formula (10) as broadly described above, for example acrylonitrile, methyl acrylate and methyl methacrylate; and copolymers of the foregoing, for example styrene-acrylonitrile (SAN), styrene-alpha-methyl styrene-acrylonitrile, methyl methacrylate-acrylonitrile-styrene, and methyl methacrylate-styrene.

In addition to the foregoing components previously described, the polycarbonate compositions further comprise a flame retardant, for example an inorganic flame retardant such as a sulfonate salt, an organic phosphates and/or an organic compound containing phosphorus-nitrogen bonds.

In an embodiment, inorganic flame retardants may also be used, for example salts of C₁₋₁₆ alkyl sulfonates such as potassium perfluoromethane sulfonate, potassium perfluorobutane sulfonate (Rimar salt), potassium perfluorooctane sulfonate, tetraethylammonium perfluorohexane sulfonate, and potassium diphenylsulfone sulfonate; salts such as CaCO₃, BaCO₃, and BaCO₃; salts of fluoro-anion complex such as Li₃AlF₆, BaSiF₆, KBF₄, K₃AlF₆, KAlF₄, K₂SiF₆, and Na₃AlF₆; and the like. When present, inorganic flame retardant salts are generally present in amounts of about 0.01 to about 25 parts by weight, more specifically about 0.1 to about 10 parts by weight, more specifically about 0.1 to about 5 parts by weight, based on 100 parts by weight of the polycarbonate component.

Organic phosphates may also be used. One type of exemplary organic phosphate is an aromatic phosphate of the formula (GO)₃P═O, wherein each G is independently an alkyl, cycloalkyl, aryl, alkaryl, or aralkyl group, provided that at least one G is an aromatic group. Two of the G groups may be joined together to provide a cyclic group, for example, diphenyl pentaerythritol diphosphate, which is described by Axelrod in U.S. Pat. No. 4,154,775. Other suitable aromatic phosphates may be, for example, phenyl bis(dodecyl)phosphate, phenyl bis(neopentyl)phosphate, phenyl bis(3,5,5′-trimethylhexyl)phosphate, ethyl diphenyl phosphate, 2-ethylhexyl di(p-tolyl)phosphate, bis(2-ethylhexyl) p-tolyl phosphate, tritolyl phosphate, bis(2-ethylhexyl)phenyl phosphate, tri(nonylphenyl)phosphate, bis(dodecyl) p-tolyl phosphate, dibutyl phenyl phosphate, 2-chloroethyl diphenyl phosphate, p-tolyl bis(2,5,5′-trimethylhexyl)phosphate, 2-ethylhexyl diphenyl phosphate, or the like. A specific aromatic phosphate is one in which each G is aromatic, for example, triphenyl phosphate, tricresyl phosphate, isopropylated triphenyl phosphate, and the like.

Di- or polyfunctional aromatic phosphorus-containing compounds are also useful, for example, compounds of the formulas below:

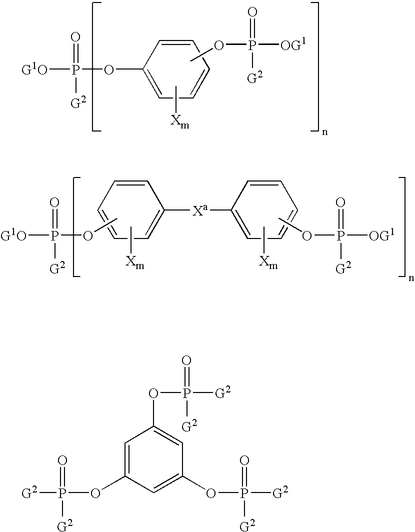

wherein each G¹ is independently a hydrocarbon having 1 to about 30 carbon atoms; each G² is independently a hydrocarbon or hydrocarbonoxy having 1 to about 30 carbon atoms; each X is independently a bromine or chlorine; m 0 to 4, and n is 1 to about 30. Examples of suitable di- or polyfunctional aromatic phosphorus-containing compounds include resorcinol tetraphenyl diphosphate (RDP), the bis(diphenyl) phosphate of hydroquinone and the bis(diphenyl) phosphate of bisphenol-A, respectively, their oligomeric and polymeric counterparts, and the like. Methods for the preparation of the aforementioned di- or polyfunctional aromatic compounds are described in British Patent No. 2,043,083.

Exemplary suitable flame retardant compounds containing phosphorus-nitrogen bonds include phosphonitrilic chloride, phosphorus ester amides, phosphoric acid amides, phosphonic acid amides, phosphinic acid amides, tris(aziridinyl) phosphine oxide. The organic phosphorus-containing flame retardants are generally present in amounts of about 0.5 to about 20 parts by weight, based on 100 parts by weight of the total composition, exclusive of any filler.

The thermoplastic composition may be essentially free of chlorine and bromine, particularly chlorine and bromine flame retardants. “Essentially free of chlorine and bromine” as used herein refers to materials produced without the intentional addition of chlorine, bromine, and/or chlorine or bromine containing materials. It is understood however that in facilities that process multiple products a certain amount of cross contamination can occur resulting in bromine and/or chlorine levels typically on the parts per million by weight scale. With this understanding it can be readily appreciated that essentially free of bromine and chlorine may be defined as having a bromine and/or chlorine content of less than or equal to about 100 parts per million by weight (ppm), less than or equal to about 75 ppm, or less than or equal to about 50 ppm. When this definition is applied to the flame retardant it is based on the total weight of the flame retardant. When this definition is applied to the thermoplastic composition it is based on the total weight of polycarbonate, optional impact modifier and flame retardant.

Exemplary suitable flame retardant compounds containing phosphorus-nitrogen bonds include phosphonitrilic chloride and tris(aziridinyl) phosphine oxide. When present, phosphorus-containing flame retardants are generally present in amounts of about 1 to about 20 parts by weight, based on 100 parts by weight of polycarbonate component and the optional impact modifier composition.

Halogenated materials may also be used as flame retardants if desired. Examples of suitable halogenated flame retardants include, but are not limited to, bis(2,6-dibromophenyl)methane; 1,1-bis-(4-iodophenyl)ethane; 2,6-bis(4,6-dichloronaphthyl)propane; 2,2-bis(2,6-dichlorophenyl)pentane; bis(4-hydroxy-2,6-dichloro-3-methoxyphenyl)methane; and 2,2-bis(3-bromo-4-hydroxyphenyl)propane. Also included within the above structural formula are 1,3-dichlorobenzene, 1,4-dibrombenzene, and biphenyls such as 2,2′-dichlorobiphenyl, polybrominated 1,4-diphenoxybenzene, 2,4′-dibromobiphenyl, and 2,4′-dichlorobiphenyl as well as decabromo diphenyl oxide, and the like. Also useful are oligomeric and polymeric halogenated aromatic compounds, such as a copolycarbonate of bisphenol A and tetrabromobisphenol A and a carbonate precursor, e.g., phosgene. Metal synergists, e.g., antimony oxide, may also be used with the flame retardant. When present, halogen containing flame retardants are generally used in amounts of about 1 to about 50 parts by weight, based on 100 parts by weight of the polycarbonate component.

In some embodiments, the composition further comprises an anti-dripping agent. In an embodiment, when a fluoro-containing anti-drip agent is utilized, it increases the melt strength of the polycarbonate, thereby reducing the tendency of the resin, when heated close to melting, to drip. Examples of suitable fluoro-containing anti-drip agents include fluoropolymer-based anti-drip agents. Suitable fluoropolymers and methods for making such fluoropolymers are known, such as for example, U.S. Pat. Nos. 3,671,487 and 3,723,373. Suitable fluoropolymers include homopolymers and copolymers that comprise structural units derived from one or more fluorinated alpha-olefin monomers. The term “fluorinated alpha-olefin monomer” means an alpha-olefin monomer that includes at least one fluorine atom substituent. Suitable fluorinated alpha-olefin monomers include, e.g., fluoroethylenes such as, tetrafluoroethylene, trifluoroethylene, 1,1-difluoroethylene, fluoroethylene, 1,1-difluoro-2-chloroethylene, 1,1-difluoro-1,1-dichloroethylene, 1,2-difluoro-1,2-dichloroethylene, 1-fluoro-2,2-dichloroethylene, 1-chloro-1-fluoroethylene, and 1,1,2-trichloro-2-fluoroethylene; and fluoropropylenes, such as e.g., hexafluoropropylene, 1,1,1,3-tetrafluoropropylene, 1,1,1,3,3-pentafluoropropylene, and 1,1,1,2-tetrafluoropropylene. In other embodiments, suitable fluorinated alpha-olefin copolymers include copolymers comprising structural units derived from two or more fluorinated alpha-olefin copolymers such as, e.g., poly(tetrafluoroethylene-hexafluoropropylene), and copolymers comprising structural units derived from one or more fluorinated monomers and one or more non-fluorinated monoethylenically unsaturated monomers that are copolymerizable with the fluorinated monomers such as, e.g., poly(tetrafluoroethylene-ethylene-propylene) copolymers. Suitable non-fluorinated monoethylenically unsaturated monomers include e.g., alpha-olefin monomers such as, e.g., ethylene, propylene, butene, acrylate monomers such as e.g., methyl methacrylate, butyl acrylate, vinyl ethers, such as, e.g., cyclohexyl vinyl ether, ethyl vinyl ether, n-butyl vinyl ether, vinyl esters such as, e.g., vinyl acetate, and vinyl versatate. The fluoropolymer can be incorporated in the composition by any of the methods known in the art, such as those disclosed in U.S. Pat. No. 6,613,824.

In a still further embodiment, the fluoropolymer is used in a minimal amount in the form of encapsulated fluoropolymer. A specific encapsulated fluoropolymer is a styrene-acrylonitrile copolymer encapsulated polytetrafluoroethylene (PTFE), or Teflon™ grafted styrene-acrylonitrile copolymer (TSAN). TSAN can be made by copolymerizing styrene and acrylonitrile in the presence of an aqueous dispersion/emulsion of Teflon™ so as to produce partially SAN-encapsulated Teflon™ particles. TSAN can, for example, comprise about 50 weight percent PTFE and about 50 weight percent styrene-acrylonitrile copolymer, based on the total weight of the encapsulated fluoropolymer. The styrene-acrylonitrile copolymer can, for example, be from about 75 weight percent styrene to about 25 weight percent acrylonitrile based on the total weight of the copolymer. TSAN offers significant advantages over polytetrafluoroethylene, namely TSAN is more readily dispersed in the composition. The TSAN particles typically have a particle size of about 35 to about 70 micrometers, and specifically about 40 to about 65 micrometers.

The relative amount of each component of the thermoplastic composition will depend on the particular type of polycarbonate(s) used, the presence of any other resins, as well as the desired properties of the composition. Particular amounts may be readily selected by one of ordinary skill in the art using the guidance provided herein.

In addition to the polycarbonate copolymer, the flame retardant, and in some embodiments the anti-dripping agent, the thermoplastic composition may include various additives such as fillers, reinforcing agents, stabilizers, and the like, with the proviso that the additives do not adversely affect the desired properties of the thermoplastic compositions. Mixtures of additives may be used. Such additives may be mixed at a suitable time during the mixing of the components for forming the composition.

Suitable fillers or reinforcing agents that may be used include, for example, silicates and silica powders such as aluminum silicate (mullite), synthetic calcium silicate, zirconium silicate, fused silica, crystalline silica graphite, natural silica sand, and the like; boron powders such as boron-nitride powder, boron-silicate powders, and the like; oxides such as TiO₂, aluminum oxide, magnesium oxide, and the like; calcium sulfate (as its anhydride, dihydrate or trihydrate); calcium carbonates such as chalk, limestone, marble, synthetic precipitated calcium carbonates, and the like; talc, including fibrous, modular, needle shaped, lamellar talc, and the like; wollastonite; surface-treated wollastonite; glass spheres such as hollow and solid glass spheres, silicate spheres, cenospheres, aluminosilicate (atmospheres), and the like; kaolin, including hard kaolin, soft kaolin, calcined kaolin, kaolin comprising various coatings known in the art to facilitate compatibility with the polymeric matrix resin, and the like; single crystal fibers or “whiskers” such as silicon carbide, alumina, boron carbide, iron, nickel, copper, and the like; fibers (including continuous and chopped fibers) such as asbestos, carbon fibers, glass fibers, such as E, A, C, ECR, R, S, D, or NE glasses, and the like; sulfides such as molybdenum sulfide, zinc sulfide and the like; barium species such as barium titanate, barium ferrite, barium sulfate, heavy spar, and the like; metals and metal oxides such as particulate or fibrous aluminum, bronze, zinc, copper and nickel and the like; flaked fillers such as glass flakes, flaked silicon carbide, aluminum diboride, aluminum flakes, steel flakes and the like; fibrous fillers, for example short inorganic fibers such as those derived from blends comprising at least one of aluminum silicates, aluminum oxides, magnesium oxides, and calcium sulfate hemihydrate and the like; natural fillers and reinforcements, such as wood flour obtained by pulverizing wood, fibrous products such as cellulose, cotton, sisal, jute, starch, cork flour, lignin, ground nut shells, corn, rice grain husks and the like; organic fillers such as polytetrafluoroethylene (Teflon™) and the like; reinforcing organic fibrous fillers formed from organic polymers capable of forming fibers such as poly(ether ketone), polyimide, polybenzoxazole, poly(phenylene sulfide), polyesters, polyethylene, aromatic polyamides, aromatic polyimides, polyetherimides, polytetrafluoroethylene, acrylic resins, poly(vinyl alcohol) and the like; as well as additional fillers and reinforcing agents such as mica, clay, feldspar, flue dust, fillite, quartz, quartzite, perlite, tripoli, diatomaceous earth, carbon black, and the like, and combinations comprising at least one of the foregoing fillers and reinforcing agents. The fillers/reinforcing agents may be coated to prevent reactions with the matrix or may be chemically passivated to neutralize catalytic degradation site that might promote hydrolytic or thermal degradation.

The fillers and reinforcing agents may be coated with a layer of metallic material to facilitate conductivity, or surface treated with silanes to improve adhesion and dispersion with the polymeric matrix resin. In addition, the reinforcing fillers may be provided in the form of monofilament or multifilament fibers and may be used either alone or in combination with other types of fiber, through, for example, co-weaving or core/sheath, side-by-side, orange-type or matrix and fibril constructions, or by other methods known to one skilled in the art of fiber manufacture. Suitable cowoven structures include, for example, glass fiber-carbon fiber, carbon fiber-aromatic polyimide (aramid) fiber, and aromatic polyimide fiberglass fiber and the like. Fibrous fillers may be supplied in the form of, for example, rovings, woven fibrous reinforcements, such as 0-90 degree fabrics and the like; non-woven fibrous reinforcements such as continuous strand mat, chopped strand mat, tissues, papers and felts and the like; or three-dimensional reinforcements such as braids. Fillers are generally used in amounts of about 0 to about 100 parts by weight, based on 100 parts by weight of the total composition.

Suitable antioxidant additives include, for example, alkylated monophenols or polyphenols; alkylated reaction products of polyphenols with dienes, such as tetrakis[methylene(3,5-di-tert-butyl-4-hydroxyhydrocinnamate)] methane, and the like; butylated reaction products of para-cresol or dicyclopentadiene; alkylated hydroquinones; hydroxylated thiodiphenyl ethers; alkylidene-bisphenols; benzyl species; esters of beta-(3,5-di-tert-butyl-4-hydroxyphenyl)-propionic acid with monohydric or polyhydric alcohols; esters of beta-(5-tert-butyl-4-hydroxy-3-methylphenyl)-propionic acid with monohydric or polyhydric alcohols; and the like; and combinations comprising at least one of the foregoing antioxidants. Antioxidants are generally used in amounts of about 0.01 to about 1, specifically about 0.1 to about 0.5 parts by weight, based on 100 parts by weight of parts by weight of the total composition.

Suitable heat and color stabilizer additives include, for example, organophosphites such as tris(2,4-di-tert-butyl phenyl)phosphite. Heat and color stabilizers are generally used in amounts of about 0.01 to about 5, specifically about 0.05 to about 0.3 parts by weight, based on 100 parts by weight of the total composition.

Suitable secondary heat stabilizer additives include, for example thioethers and thioesters such as pentaerythritol tetrakis (3-(dodecylthio)propionate), pentaerythritol tetrakis[3-(3,5-di-tert-butyl-4-hydroxyphenyl)propionate], dilauryl thiodipropionate, distearyl thiodipropionate, dimyristyl thiodipropionate, ditridecyl thiodipropionate, pentaerythritol octylthiopropionate, dioctadecyl disulphide, and the like, and combinations comprising at least one of the foregoing heat stabilizers. Secondary stabilizers are generally used in amount of about 0.01 to about 5, specifically about 0.03 to about 0.3 parts by weight, based upon 100 parts by weight of the total composition.

Light stabilizers, including ultraviolet light (UV) absorbing additives, may also be used. Suitable stabilizing additives of this type include, for example, benzotriazoles and hydroxybenzotriazoles such as 2-(2-hydroxy-5-methylphenyl)benzotriazole, 2-(2-hydroxy-5-tert-octylphenyl)-benzotriazole, 2-(2H-benzotriazol-2-yl)-4-(1,1,3,3-tetramethylbutyl)-phenol (CYASORB™ 5411 from Cytec), and TINUVIN™ 234 from Ciba Specialty Chemicals; hydroxybenzotriazines; hydroxyphenyl-triazine or -pyrimidine UV absorbers such as TINUVIN™ 1577 (Ciba), and 2-[4,6-bis(2,4-dimethylphenyl)-1,3,5-triazin-2-yl]-5-(octyloxy)-phenol (CYASORB™ 1164 from Cytec); non-basic hindered amine light stabilizers (hereinafter “HALS”), including substituted piperidine moieties and oligomers thereof, for example 4-piperidinol derivatives such as TINUVIN™ 622 (Ciba), GR-3034, TINUVIN™ 123, and TINUVIN™ 440; benzoxazinones, such as 2,2′-(1,4-phenylene)bis(4H-3,1-benzoxazin-4-one) (CYASORB™ UV-3638); hydroxybenzophenones such as 2-hydroxy-4-n-octyloxybenzophenone (CYASORB™ 531); oxanilides; cyanoacrylates such as 1,3-bis[(2-cyano-3,3-diphenylacryloyl)oxyl-2,2-bis[[(2-cyano-3,3-diphenylacryloyl)oxy]methyl]propane (UVINUL™ 3030) and 1,3-bis[(2-cyano-3,3-diphenylacryloyl)oxyl-2,2-bis[[(2-cyano-3,3-diphenylacryloyl)oxylmethyl]propane; and nano-size inorganic materials such as titanium oxide, cerium oxide, and zinc oxide, all with particle size less than about 100 nanometers; and the like, and combinations comprising at least one of the foregoing stabilizers. Light stabilizers may be used in amounts of about 0.01 to about 10, specifically about 0.1 to about 1 parts by weight, based on 100 parts by weight of parts by weight of the polycarbonate component and the impact modifier composition. UV absorbers are generally used in amounts of about 0.1 to about 5 parts by weight, based on 100 parts by weight of the total composition.

Plasticizers, lubricants, and/or mold release agents additives may also be used. There is considerable overlap among these types of materials, which include, for example, phthalic acid esters such as dioctyl-4,5-epoxy-hexahydrophthalate; tris-(octoxycarbonylethyl)isocyanurate; tristearin; di- or polyfunctional aromatic phosphates such as resorcinol tetraphenyl diphosphate (RDP), the bis(diphenyl) phosphate of hydroquinone and the bis(diphenyl) phosphate of bisphenol-A; poly-alpha-olefins; epoxidized soybean oil; silicones, including silicone oils; esters, for example, fatty acid esters such as alkyl stearyl esters, e.g., methyl stearate; stearyl stearate, pentaerythritol tetrastearate, and the like; mixtures of methyl stearate and hydrophilic and hydrophobic nonionic surfactants comprising polyethylene glycol polymers, polypropylene glycol polymers, and copolymers thereof, e.g., methyl stearate and polyethylene-polypropylene glycol copolymers in a suitable solvent; waxes such as beeswax, montan wax, paraffin wax and the like; and poly alpha olefins such as Ethylflo™ 164, 166, 168, and 170. Such materials are generally used in amounts of about 0.1 to about 20 parts by weight, specifically about 1 to about 10 parts by weight, based on 100 parts by weight of the total composition.

Colorants such as pigment and/or dye additives may also be present. Suitable pigments include for example, inorganic pigments such as metal oxides and mixed metal oxides such as zinc oxide, titanium dioxides, iron oxides and the like; sulfides such as zinc sulfides, and the like; aluminates; sodium sulfo-silicates sulfates, chromates, and the like; carbon blacks; zinc ferrites; ultramarine blue; Pigment Brown 24; Pigment Red 101; Pigment Yellow 119; organic pigments such as azos, di-azos, quinacridones, perylenes, naphthalene tetracarboxylic acids, flavanthrones, isoindolinones, tetrachloroisoindolinones, anthraquinones, anthanthrones, dioxazines, phthalocyanines, and azo lakes; Pigment Blue 60, Pigment Red 122, Pigment Red 149, Pigment Red 177, Pigment Red 179, Pigment Red 202, Pigment Violet 29, Pigment Blue 15, Pigment Green 7, Pigment Yellow 147 and Pigment Yellow 150, and combinations comprising at least one of the foregoing pigments. Pigments may be coated to prevent reactions with the matrix or may be chemically passivated to neutralize catalytic degradation site that might promote hydrolytic or thermal degradation. Pigments are generally used in amounts of about 0.01 to about 10 parts by weight, based on 100 parts by weight of the total composition.

Suitable dyes are generally organic materials and include, for example, coumarin dyes such as coumarin 460 (blue), coumarin 6 (green), nile red and the like; lanthanide complexes; hydrocarbon and substituted hydrocarbon dyes; polycyclic aromatic hydrocarbon dyes; scintillation dyes such as oxazole or oxadiazole dyes; aryl- or heteroaryl-substituted poly (C₂-C₈) olefin dyes; carbocyanine dyes; indanthrone dyes; phthalocyanine dyes; oxazine dyes; carbostyryl dyes; napthalenetetracarboxylic acid dyes; porphyrin dyes; bis(styryl)biphenyl dyes; acridine dyes; anthraquinone dyes; cyanine dyes; methine dyes; arylmethane dyes; azo dyes; indigoid dyes, thioindigoid dyes, diazonium dyes; nitro dyes; quinone imine dyes; aminoketone dyes; tetrazolium dyes; thiazole dyes; perylene dyes, perinone dyes; bis-benzoxazolylthiophene (BBOT); triarylmethane dyes; xanthene dyes; thioxanthene dyes; naphthalimide dyes; lactone dyes; fluorophores such as anti-stokes shift dyes which absorb in the near infrared wavelength and emit in the visible wavelength, and the like; luminescent dyes such as 5-amino-9-diethyliminobenzo(a)phenoxazonium perchlorate; 7-amino-4-methylcarbostyryl; 7-amino-4-methylcoumarin; 7-amino-4-trifluoromethylcoumarin; 3-(2′-benzimidazolyl)-7-N,N-diethylaminocoumarin; 3-(2′-benzothiazolyl)-7-diethylaminocoumarin; 2-(4-biphenylyl)-5-(4-t-butylphenyl)-1,3,4-oxadiazole; 2-(4-biphenylyl)-5-phenyl-1,3,4-oxadiazole; 2-(4-biphenyl)-6-phenylbenzoxazole-1,3; 2,5-bis-(4-biphenylyl)-1,3,4-oxadiazole; 2,5-bis-(4-biphenylyl)-oxazole; 4,4′-bis-(2-butyloctyloxy)-p-quaterphenyl; p-bis(o-methylstyryl)-benzene; 5,9-diaminobenzo(a)phenoxazonium perchlorate; 4-dicyanomethylene-2-methyl-6-(p-dimethylaminostyryl)-4H-pyran; 1,1′-diethyl-2,2′-carbocyanine iodide; 1,1′-diethyl-4,4′-carbocyanine iodide; 3,3′-diethyl-4,4′,5,5′-dibenzothiatricarbocyanine iodide; 1,1′-diethyl-4,4′-dicarbocyanine iodide; 1,1′-diethyl-2,2′-dicarbocyanine iodide; 3,3′-diethyl-9,11-neopentylenethiatricarbocyanine iodide; 1,3′-diethyl-4,2′-quinolyloxacarbocyanine iodide; 1,3′-diethyl-4,2′-quinolylthiacarbocyanine iodide; 3-diethylamino-7-diethyliminophenoxazonium perchlorate; 7-diethylamino-4-methylcoumarin; 7-diethylamino-4-trifluoromethylcoumarin; 7-diethylaminocoumarin; 3,3′-diethyloxadicarbocyanine iodide; 3,3′-diethylthiacarbocyanine iodide; 3,3′-diethylthiadicarbocyanine iodide; 3,3′-diethylthiatricarbocyanine iodide; 4,6-dimethyl-7-ethylaminocoumarin; 2,2′-dimethyl-p-quaterphenyl; 2,2-dimethyl-p-terphenyl; 7-dimethylamino-1-methyl-4-methoxy-8-azaquinolone-2; 7-dimethylamino-4-methylquinolone-2; 7-dimethylamino-4-trifluoromethylcoumarin; 2-(4-(4-dimethylaminophenyl)-1,3-butadienyl)-3-ethylbenzothiazolium perchlorate; 2-(6-(p-dimethylaminophenyl)-2,4-neopentylene-1,3,5-hexatrienyl)-3-methylbenzothiazolium perchlorate; 2-(4-(p-dimethylaminophenyl)-1,3-butadienyl)-1,3,3-trimethyl-3H-indolium perchlorate; 3,3′-dimethyloxatricarbocyanine iodide; 2,5-diphenylfuran; 2,5-diphenyloxazole; 4,4′-diphenylstilbene; 1-ethyl-4-(4-(p-dimethylaminophenyl)-1,3-butadienyl)-pyridinium perchlorate; 1-ethyl-2-(4-(p-dimethylaminophenyl)-1,3-butadienyl)-pyridinium perchlorate; 1-ethyl-4-(4-(p-dimethylaminophenyl)-1,3-butadienyl)-quinolium perchlorate; 3-ethylamino-7-ethylimino-2,8-dimethylphenoxazin-5-ium perchlorate; 9-ethylamino-5-ethylamino-10-methyl-5H-benzo(a) phenoxazonium perchlorate; 7-ethylamino-6-methyl-4-trifluoromethylcoumarin; 7-ethylamino-4-trifluoromethylcoumarin; 1,1′,3,3,3′,3′-hexamethyl-4,4′,5,5′-dibenzo-2,2′-indotricarboccyanine iodide; 1,1′,3,3,3′,3′-hexamethylindodicarbocyanine iodide; 1,1′,3,3,3′,3′-hexamethylindotricarbocyanine iodide; 2-methyl-5-t-butyl-p-quaterphenyl; N-methyl-4-trifluoromethylpiperidino-<3,2-g>coumarin; 3-(2′-N-methylbenzimidazolyl)-7-N,N-diethylaminocoumarin; 2-(1-naphthyl)-5-phenyloxazole; 2,2′-p-phenylen-bis(5-phenyloxazole); 3,5,3″″,5″″-tetra-t-butyl-p-sexiphenyl; 3,5,3″″,5″″-tetra-t-butyl-p-quinquephenyl; 2,3,5,6-1H,4H-tetrahydro-9-acetylquinolizino-<9,9a,1-gh>coumarin; 2,3,5,6-1H,4H-tetrahydro-9-carboethoxyquinolizino-<9,9a,1-gh>coumarin; 2,3,5,6-1H,4H-tetrahydro-8-methylquinolizino-<9,9a, 1-gh>coumarin; 2,3,5,6-1H,4H-tetrahydro-9-(3-pyridyl)-quinolizino-<9,9a,1-gh>coumarin; 2,3,5,6-1H,4H-tetrahydro-8-trifluoromethylquinolizino-<9,9a,1-gh>coumarin; 2,3,5,6-1 H,4H-tetrahydroquinolizino-<9,9a,1-gh>coumarin; 3,3′,2″,3′″-tetramethyl-p-quaterphenyl; 2,5,2″″,5′″-tetramethyl-p-quinquephenyl; P-terphenyl; P-quaterphenyl; nile red; rhodamine 700; oxazine 750; rhodamine 800; IR 125; IR 144; IR 140; IR 132; IR 26; IR5; diphenylhexatriene; diphenylbutadiene; tetraphenylbutadiene; naphthalene; anthracene; 9,10-diphenylanthracene; pyrene; chrysene; rubrene; coronene; phenanthrene and the like, and combinations comprising at least one of the foregoing dyes. Dyes are generally used in amounts of about 0.1 parts per million to about 10 parts by weight, based on 100 parts by weight of the total composition.

Monomeric, oligomeric, or polymeric antistatic additives that may be sprayed onto the article or processed into the thermoplastic composition may be advantageously used. Examples of monomeric antistatic agents include long chain esters such as glycerol monostearate, glycerol distearate, glycerol tristearate, and the like, sorbitan esters, and ethoxylated alcohols, alkyl sulfates, alkylarylsulfates, alkylphosphates, alkylaminesulfates, alkyl sulfonate salts such as sodium stearyl sulfonate, sodium dodecylbenzenesulfonate and the like, fluorinated alkylsulfonate salts, betaines, and the like. Combinations of the foregoing antistatic agents may be used. Exemplary polymeric antistatic agents include certain polyetheresters, each containing polyalkylene glycol moieties such as polyethylene glycol, polypropylene glycol, polytetramethylene glycol, and the like. Such polymeric antistatic agents are commercially available, and include, for example PELESTAT™ 6321 (Sanyo), PEBAX™ MH1657 (Atofina), and IRGASTAT™ P18 and P22 (Ciba-Geigy). Other polymeric materials that may be used as antistatic agents are inherently conducting polymers such as polythiophene (commercially available from Bayer), which retains some of its intrinsic conductivity after melt processing at elevated temperatures. In one embodiment, carbon fibers, carbon nanofibers, carbon nanotubes, carbon black or any combination of the foregoing may be used in a polymeric resin containing chemical antistatic agents to render the composition electrostatically dissipative. Antistatic agents are generally used in amounts of about 0.1 to about 10 parts by weight, based on 100 parts by weight total composition.

Where a foam is desired, suitable blowing agents include, for example, low boiling halohydrocarbons and those that generate carbon dioxide; blowing agents that are solid at room temperature and when heated to temperatures higher than their decomposition temperature, generate gases such as nitrogen, carbon dioxide, ammonia gas, such as azodicarbonamide, metal salts of azodicarbonamide, 4,4′-oxybis(benzenesulfonylhydrazide), sodium bicarbonate, ammonium carbonate, and the like, or combinations comprising at least one of the foregoing blowing agents. Blowing agents are generally used in amounts of about 0.5 to about 20 parts by weight, based on 100 parts by weight of the total composition.

The thermoplastic compositions may be manufactured by methods generally available in the art, for example, in one embodiment, in one manner of proceeding, powdered polycarbonate or polycarbonates, impact modifier, and/or other optional components are first blended, optionally with fillers in a Henschel™ high speed mixer. Other low shear processes including but not limited to hand mixing may also accomplish this blending. The blend is then fed into the throat of an extruder via a hopper. Alternatively, one or more of the components may be incorporated into the composition by feeding directly into the extruder at the throat and/or downstream through a sidestuffer. Such additives may also be compounded into a masterbatch with a desired polymeric resin and fed into the extruder. The additives may be added to either the polycarbonate base materials or the impact modifier base material to make a concentrate, before this is added to the final product. The extruder is generally operated at a temperature higher than that necessary to cause the composition to flow, typically 500° F. (260° C.) to 650° F. (343° C.). The extrudate is immediately quenched in a water batch and pelletized. The pellets, so prepared, when cutting the extrudate may be one-fourth inch long or less as desired. Such pellets may be used for subsequent molding, shaping, extruding or forming.

Shaped, formed, or molded articles comprising the thermoplastic compositions are also provided. The thermoplastic compositions may be molded into useful shaped articles by a variety of means such as injection molding, extrusion, rotational molding, blow molding and thermoforming to form articles such as, for example, computer and business machine housings such as housings for monitors, handheld electronic device housings such as housings for cell phones, battery packs, electrical connectors, and components of lighting fixtures, televisions, ornaments, home appliances, roofs, greenhouses, sun rooms, swimming pool enclosures, and the like.

The compositions find particular utility in electronics, business equipment and equipment housings, such as televisions, computers, notebook computers, cell phones, battery packs, Personal Data Assistants (PDAs), printers, copiers, projectors, facsimile machines, wireless devices, digital cameras and camera housings, television bezels, and other equipment and devices known in the art.

Heat Deflection Temperature (HDT) is a relative measure of a material's ability to perform for a short time at elevated temperatures while supporting a load. The test measures the effect of temperature on stiffness: a standard test specimen is given a defined surface stress and the temperature is raised at a uniform rate. Heat Deflection Test (HDT) was determined per ASTM D648, using a flat, one-eighth inch thick bar, molded Tensile bar subjected to 264 psi.

Notched Izod Impact strength (NII) was determined on one-eighth inch (3.12 mm) bars per ASTM D256. Izod Impact Strength ASTM D256 is used to compare the impact resistances of plastic materials. The results are defined as the impact energy used to break the test specimen, divided by the specimen area at the notch. Results are reported in lb.f/in.

Melt Flow Rate (MFR) or Melt Volume Rate (MVR) was determined at 300° C. using a 1.2-kilogram weight over 6 minutes in accordance with or ASTM 1238-04. Results are reported in cm³/10 min.

Tensile Modulus was determined using Type I 3.2 mm thick molded tensile bars and tested per ASTM D638 at a pull rate of 1 mm/min. until 1% strain, followed by a rate of 50 mm/min. until the sample broke. It is also possible to measure at 5 mm/min. if desired for the specific application, but the samples measured in these experiments were measured at 50 mm/min. Tensile Modulus results are reported as MPa, and Tensile Elongation at Break is reported as a percentage.

Haze (%) was determined according to ASTM D1003-00 using a Gardner Haze Guard Dual, on 3.2 millimeter thick molded plaques.

Transmission (%) was determined according to ASTM D1003-00 using a Gardner Haze Guard Dual, on 3.2 millimeter thick molded plaques.

Scratch Testing was measured using the Pencil Hardness Test according to ASTM D3363-92a, which describes a procedure for rapid, inexpensive determination of the film hardness of an organic coating on a substrate in terms of drawing leads or pencil leads of known hardness ranging in order of softest to hardest: 6B, 5B, 4B, 3B, 2B, B, HB, F, H, 2H, 3H, 4H, 5H, 6H. In the method, a coated panel (or other test substrate) is placed on a firm horizontal surface. The pencil is held firmly against the film or substrate at a 45 degree angle (with the point directed away from the operator) and pushed away from the operator in a single stroke of 6.5 mm in length. The process is started with the hardest pencil and continued down the scale of hardness to either of two end points; one, the pencil that will not cut into or gouge the film (pencil hardness), or two, the pencil that will not scratch the film (scratch hardness). Higher pencil hardness and shallower scratches (lower scratch depths) indicate better scratch resistance.

Flammability tests were performed following the procedure of Underwriter's Laboratory Bulletin 94 entitled “Tests for Flammability of Plastic Materials, UL94.” According to this procedure, materials may be classified as HB, V0, V1, V2, 5VA and/or 5VB on the basis of the test results obtained for five samples at the specified sample thicknesses. The samples are made according to the UL94 test procedure using standard ASTM molding criteria. The criteria for each of the flammability classifications tested are described below.

V0: In a sample placed so that its long axis is 180 degrees to the flame, the average period of flaming and/or smoldering after removing the igniting flame does not exceed five seconds and none of the vertically placed samples produces drips of burning particles that ignite absorbent cotton, and no specimen burns up to the holding clamp after flame or after glow. Five bar flame out time (FOT) is the sum of the flame out time for five bars, each lit twice for ten (10) seconds each, for a maximum flame out time of 50 seconds. FOT1 is the average flame out time after the first light. FOT2 is the average flame out time after the second light.

V1, V2, FOT: In a sample placed so that its long axis is 180 degrees to the flame, the average period of flaming and/or smoldering after removing the igniting flame does not exceed twenty-five seconds and, for a V1 rating, none of the vertically placed samples produces drips of burning particles that ignite absorbent cotton. The V2 standard is the same as V1, except that drips are permitted. Five bar flame out time (FOT) is the sum of the flame out time for five bars, each lit twice for ten (10) seconds each, for a maximum flame out time of 250 seconds.

The data was also analyzed by calculating the average flame out time, standard deviation of the flame out time and the total number of drips, and by using statistical methods to convert that data to a prediction of the probability of first time pass, or “p(FTP)”, that a particular sample formulation would achieve a “pass” rating in the conventional UL94 V0 or V1 testing of 5 bars. The probability of a first time pass on a first submission (pFTP) may be determined according to the formula:

pFTP=(P_{t1>mbt, n=0}×P_{t2>mbt, n=0}×P_{total<=mtbt}×P_{drip, n=0})

where P_{t1>mbt, n=0} is the probability that no first burn time exceeds a maximum burn time value, P_{t2>mbt, n=0} is the probability that no second burn time exceeds a maximum burn time value, P_{total<=mtbt} is the probability that the sum of the burn times is less than or equal to a maximum total burn time value, and P_{drip, n=0} is the probability that no specimen exhibits dripping during the flame test. First and second burn time refer to burn times after a first and second application of the flame, respectively.

The probability that no first burn time exceeds a maximum burn time value, P_{t1>mbt, n=0}, may be determined from the formula:

P_{t1>mbt, n=0}=(1−P_{t1>mbt})⁵

where P_{t1>mbt} is the area under the log normal distribution curve for t1>mbt, and where the exponent “5” relates to the number of bars tested.

The probability that no second burn time exceeds a maximum burn time value may be determined from the formula:

P_{t2>mbt, n=0}=(1−P_{t2>mbt})

where P_{t2>mbt} is the area under the normal distribution curve for t2>mbt. As above, the mean and standard deviation of the burn time data set are used to calculate the normal distribution curve. For the UL-94 V0 rating, the maximum burn time is 10 seconds. For a V1 or V2 rating the maximum burn time is 30 seconds⁵.

The probability P_{drip, n=0} that no specimen exhibits dripping during the flame test is an attribute function, estimated by:

(1−P_{drip})⁵

where P_{drip}=(the number of bars that drip/the number of bars tested).

The probability P_{total <=mtbt} that the sum of the burn times is less than or equal to a maximum total burn time value may be determined from a normal distribution curve of simulated 5-bar total burn times. The distribution may be generated from a Monte Carlo simulation of 1000 sets of five bars using the distribution for the burn time data determined above. Techniques for Monte Carlo simulation are well known in the art. A normal distribution curve for 5-bar total burn times may be generated using the mean and standard deviation of the simulated 1000 sets. Therefore, P_{total<=mtbt} may be determined from the area under a log normal distribution curve of a set of 1000 Monte Carlo simulated 5-bar total burn time for total<=maximum total burn time. For the UL-94 V-0 rating, the maximum total burn time is 50 seconds. For a V1 or V2 rating, the maximum total burn time is 250 seconds.

Preferably, p(FTP) is as close to 1 as possible, for example, greater than or equal to about 0.7, optionally greater than or equal to about 0.85, optionally greater than or equal to about 0.9 or, more specifically, greater than or equal to about 0.95, for maximum flame-retardant performance in UL testing. The p(FTP)≧0.7, and specifically, p(FTP)≧0.85, is a more stringent standard than merely specifying compliance with the referenced V0 or V1 test.

The invention is further illustrated by the following non-limiting Examples.

Samples were prepared by melt extrusion on a Werner & Pfleiderer 25 mm twin screw extruder, using a nominal melt temperature of 260 to 275° C., 25 inches (635 mm) of mercury vacuum and 400 rpm. The extrudate was pelletized and dried at about 120° C. for about 4 hours.

To make test specimens, the dried pellets were injection molded on a Van Dorn 85-ton injection molding machine at a nominal temperature of 245 to 270° C. to form specimens for most of the tests below. Test bars for flame testing were injection molded at a nominal temperature of 245 to 270° C. on a Husky injection molding machine. Specimens were tested in accordance with ASTM or ISO standards as described above. The following components were used:

TABLE 1

| Component | Type | Source |
|---|---|---|
| PC-1 | High flow BPA polycarbonate resin made by the | GE Plastics |
| | interfacial process with a molecular weight of about | |
| | 22,000 (measured against polycarbonate standards) | |
| PC-2 | BPA polycarbonate resin made by the interfacial | GE Plastics |
| | process with a molecular weight of about 29,500 | |
| | (measured against polycarbonate standards) | |
| PC-3 | Branched PC made by the interfacial process with a | GE Plastics |
| | molecular weight of 37,700 (measured against | |
| | polycarbonate standards) | |
| PC-4 | DMBPC copolymer comprising 50 mol % DMBPC and | GE Plastics |
| | 50 mol. % BPA polycarbonate having a molecular | |
| | weight of about 23,500 (measured against | |
| | polycarbonate standards) | |
| PC-5 | DMBPC copolymer comprising 25 mol % DMBPC and | GE Plastics |
| | 75 mol. % BPA polycarbonate having a molecular | |
| | weight of about 18,900 (measured against | |
| | polycarbonate standards) | |
| PC-6 | BPA polycarbonate resin made by the interfacial | GE Plastics |
| | process having a molecular weight of about 23,300 | |
| | (measured against polycarbonate standards) | |
| PC-Si | Transparent Polysiloxane-polycarbonate copolymer | GE Plastics |
| | comprising 80 wt. % units derived from BPA and 6 wt. % | |
| | units derived from dimethylsiloxane | |
| PC-7 | Resorcinol based polyaryl ester copolymer comprising | GE Plastics |
| | 20 wt. % units derived from Resorcinol based polyaryl | |
| | ester and 80 wt. % units derived from BPA, having a | |
| | molecular weight of 31,000 (measured against | |
| | polycarbonate standards) | |
| PC-8 | Brominated BPA polycarbonate having a molecular | GE Plastics |
| | weight of 23,000 (measured against polycarbonate | |
| | standards) | |
| FR-1 | Potassium perfluorobutane sulfonate (C₄ K Rimar Salt | Bayer, 3M |
| | or KPFBS) | |
| FR-2 | Potassium diphenylsulfone sulfonate (KSS) | Seal Sands, |
| | | Sloss, |
| | | Metropolitan |
| FR-3 | Potassium perfluoromethane sulfonate (C₁ K Rimar | 3M |
| | Salt) | |
| TSAN | PTFE encapsulated in SAN (50 wt. % PTFE, 50 wt. % | GE Plastics |
| | SAN) | |

Samples were produced according to the methods described above using the materials in Table 1, and testing according to the test methods previously described. The sample formulations are shown in Table 2 and test results are shown in Table 3 below.

TABLE 2

| COMPONENTS | Units | 1 | 2 | 3 | 4 | 5 | 6 | 7 | 8 | 9 | 10 |
|---|---|---|---|---|---|---|---|---|---|---|---|
| PC-1 | % | 100 | 100 | 0 | 0 | 0 | 0 | 90 | 80 | 95 | 88 |
| PC-2 | % | 0 | 0 | 0 | 0 | 25 | 30 | 10 | 20 | 0 | 0 |
| PC-3 | % | 0 | 0 | 0 | 0 | 0 | 0 | 0 | 0 | 5 | 12 |
| PC-5 | % | 0 | 0 | 100 | 100 | 75 | 70 | 0 | 0 | 0 | 0 |
| FR-1 | % | 0 | 0.08 | 0 | 0.08 | 0.08 | 0.08 | 0.08 | 0.08 | 0.08 | 0.08 |
| Others* | % | 0.40 | 0.40 | 0.40 | 0.40 | 0.40 | 0.40 | 0.40 | 0.40 | 0.40 | 0.40 |

*An additive package comprising 0.05 wt. % antioxidant (Irgaphos ™ 168) and 0.35 wt % mold release agent (based on 100% by weight of the total composition) was also added to all samples.

TABLE 3

| PHYSICAL | | | | | | | | | | | |
|---|---|---|---|---|---|---|---|---|---|---|---|
| PROPERTIES | | 1 | 2 | 3 | 4 | 5 | 6 | 7 | 8 | 9 | 10 |
| NII, 23° C. | lb.f/in. | 13.26 | 13.52 | 0.23 | 0.31 | 0.44 | 0.35 | 13.45 | 14.90 | NA | NA |
| Melt Flow | cm³/ | 28.29 | 28.71 | 24.5 | 25.9 | 24.5 | 20.6 | 23.28 | 20.23 | 24.51 | 20.47 |
| | 10 min. | | | | | | | | | | |
| HDT (⅛″ at | ° C. | 122.5 | 122.7 | 119 | 119.9 | 121.8 | 120.0 | 123.2 | 123.9 | NA | NA |
| 264 psi) | | | | | | | | | | | |
| Tensile | kpsi | 355 | 351 | 370 | 375 | 383 | 374 | 349 | 349 | NA | NA |
| Modulus at | | | | | | | | | | | |
| 50 mm/m | | | | | | | | | | | |
| Haze | % | 0.6 | 0.5 | 0.9 | 1.0 | 0.7 | 0.8 | 1.0 | 0.6 | NA | NA |
| Transmission | % | 89.80 | 89.74 | 88.71 | 88.56 | 88.5 | 89.2 | 89.0 | 89.0 | NA | NA |
| p(FTP) at 3.0 mm | — | 0 | 0.22 | 0 | 0.69 | 0.98 | 0.95 | 0 | 0 | 0 | 0.28 |
| Flaming | Yes/ | Yes | Yes | Yes | No | No | No | Yes | Yes | Yes | No |
| Drips | No | | | | | | | | | | |

*NA—not available.

The above results illustrate that the formulations with high flow polycarbonate (Examples 1 and 2, with and without flame retardant) exhibited drip behavior due to poor melt strength. Similarly, Example 3 (without flame retardant) containing the DMBPC copolymer also exhibited drip behavior, but Example 4 (with flame retardant) did not show a drip behavior at a comparable high flow, and had an acceptable p(FTP) of 0.69. Examples 5 and 6 were made by blending low melt flow polycarbonate with the DMBPC copolymer to achieve various melt flows. These blends exhibited robust flame performance at 3.0 mm, as shown by the p(FTP) of greater than 0.90 and no drips. Examples 7 to 10 were formulated with blends of various polycarbonates without the DMBPC copolymer to attain a melt flow in the 20 to 25 melt flow range. None of Examples 7 to 10 exhibited good flame performance as shown in Table 3. The blends with the branched polycarbonate, which has the highest melt strength, the highest molecular weight and lowest melt flow did not result in robust FR performance while the Examples with the DMBPC copolymer (which has the lowest molecular weight and highest melt flow) and flame retardant (Examples 4 to 6) resulted in good FR performance. This translates into higher melt strength capability imparted by the use of the DMBPC copolymer.

The melt strength and viscosity take-off temperature were measured. The melt strength evaluation was performed via high temperature rheology measurements on a rheometer Ares equipped with 25 mm parallel plates that hold the pellet samples. The branching reaction (viscosity build-up) temperature was determined by performing a temperature sweep, by hot air, at 10° C./min in the range 300° C. to 430° C. Example 1, which has high flow PC, without a flame retardant additive, exhibited a viscosity build-up at around 390° C. Example 2, also with high flow PC but with a flame retardant additive exhibited viscosity build-up at a lower temperature (at around 378° C.). It is this viscosity build-up at the lower temperature, due to the presence of the FR additive, which helps in achieving UL94 V0 performance for lower melt flow PC compositions. Comparatively, Example 3, which has DMBPC copolymer, but without flame retardant, had a viscosity build-up at 350° C., which is 40° C. earlier than Example 1. Similarly, Example 4, also with DMPBC copolymer, as well as flame retardant, had the viscosity build-up at around 338° C., which is again 40° C. lower then Example 2, which did not have DMBPC. This clearly demonstrates the superior melt strength capability of the DMBPC copolymer at the flame retardancy testing temperature even though the initial melt flow is comparable to that of high flow PC. Additionally, Example 4 did not exhibit drip behavior and thus had good flame performance.

Additional samples were produced using the components in Table 1, and tested according to the test methods previously described. The sample formulations are shown in Tables 4 and 6 and test results are shown in Tables 5 and 7 below.

TABLE 4

| COMPONENTS | Units | 11 | 12 | 13 | 14 | 15 | 16 | 17 | 18 |
|---|---|---|---|---|---|---|---|---|---|
| PC-1 | % | 100 | 100 | 0 | 0 | 0 | 0 | 90 | 80 |
| PC-2 | % | 0 | 0 | 0 | 0 | 25 | 30 | 10 | 20 |
| PC-5 | % | 0 | 0 | 100 | 100 | 75 | 70 | 0 | 0 |
| FR-2 | % | 0 | 0.3 | 0 | 0.3 | 0 | 0 | 0 | 0 |
| FR-3 | % | 0 | 0 | 0 | 0 | 0 | 0.04 | 0 | 0.04 |
| PC-8 | % | 0 | 1.25 | 0 | 1.25 | 0 | 0 | 0 | 0 |
| Others* | % | 0.40 | 0.40 | 0.40 | 0.40 | 0.40 | 0.40 | 0.40 | 0.40 |

*An additive package comprising 0.05 wt. % antioxidant (Irgaphos ™ 168) and 0.35 wt % mold release agent (based on 100% by weight of the total composition) was also added to all samples.

TABLE 5

| PHYSICAL | | | | | | | | | |
|---|---|---|---|---|---|---|---|---|---|
| PROPERTIES | | 11 | 12 | 13 | 14 | 15 | 16 | 17 | 18 |
| NII, 23° C. | lb.f/in. | 13.32 | 13.87 | 0.2 | 0.2 | 13.63 | 13.23 | 0.19 | 0.20 |
| HDT (⅛″ at | ° C. | 122.8 | 123.7 | 114.7 | 116.1 | 124.9 | 124.3 | 115.4 | 114.9 |
| 264 psi) | | | | | | | | | |
| Tensile | kpsi | 344 | 344 | 397 | 402 | 342 | 344 | 392 | 400 |
| Modulus at 50 mm/m | | | | | | | | | |
| Haze | % | 0.5 | 1.2 | 0.7 | 1.9 | 0.7 | 0.6 | 0.6 | 0.74 |
| Transmission | % | 89.6 | 89.4 | 89.4 | 89.3 | 89.5 | 89.6 | 89.5 | 89.0 |

*NA—not available.

TABLE 6

| COMPONENTS | Units | 19 | 20 | 21 | 22 | 23 | 24 |
|---|---|---|---|---|---|---|---|
| PC-1 | % | 60 | 50 | 0 | 0 | 0 | 0 |
| PC-2 | % | 40 | 40 | 0 | 0 | 0 | 0 |
| PC-5 | % | 0 | 10 | 0 | 25 | 0 | 50 |
| PC-Si | % | 0 | 0 | 100 | 75 | 0 | 0 |
| PC-7 | % | 0 | 0 | 0 | 0 | 100 | 50 |
| FR-1 | % | 0.08 | 0.08 | 0.08 | 0.08 | 0.08 | 0.08 |
| TSAN | % | 0.5 | 0.5 | 0 | 0 | 0 | 0 |
| Others* | % | 0.40 | 0.40 | 0.40 | 0.40 | 0.40 | 0.40 |

*An additive package comprising 0.05 wt. % antioxidant (Irgaphos ™ 168) and 0.35 wt % mold release agent (based on 100% by weight of the total composition) was also added to all samples.

TABLE 7

| PHYSICAL | | | | | | | |
|---|---|---|---|---|---|---|---|
| PROPERTIES | | 19 | 20 | 21 | 22 | 23 | 24 |
| NII, 23° C. | lb.f/in. | 15.84 | 8.61 | 13.43 | 12.34 | 15.35 | 0.89 |
| Melt Flow | cm³/10 min. | 15.42 | 15.47 | NA | NA | NA | NA |
| HDT (⅛″ at | ° C. | 125.6 | 126.8 | 114.7 | 116.1 | 119.2 | 118.5 |
| 264 psi) | | | | | | | |
| Tensile | kpsi | 355 | 354 | 310 | 334 | 355 | 375 |
| Modulus at 50 mm/m | | | | | | | |
| Haze | % | NA | NA | 2.8 | 3.0 | 0.4 | 1.0 |
| Transmission | % | NA | NA | 83 | 83 | 89 | 88 |
| p(FTP) at 1.13 mm | — | 0.63 | 0.95 | NA | NA | NA | NA |
| Flaming Drips | Yes/No | No | No | NA | NA | NA | NA |

*NA—not available.

The above results illustrate that compositions made with different flame retardants also had good melt strength. The Examples made with DMBPC copolymer blended with high flow polycarbonate and an anti-dripping agent (Example 20) had superior melt strength and robust V0 performance at a thickness of 1.13 mm compared to the non-DMBPC blend. Additional samples were made with the DMBPC copolymer and other types of polycarbonate copolymers. Example 21 is a transparent polycarbonate-polysiloxane copolymer, and Example 22 is a blend of the DMBPC copolymer with a transparent polysiloxane-polycarbonate copolymer. Example 22 exhibits better melt strength than Example 21. Example 23 is a resorcinol polyester-polycarbonate, and Example 24 is a blend of the DMBPC copolymer with a resorcinol polyester-polycarbonate. Example 24 exhibits better melt strength than Example 23.

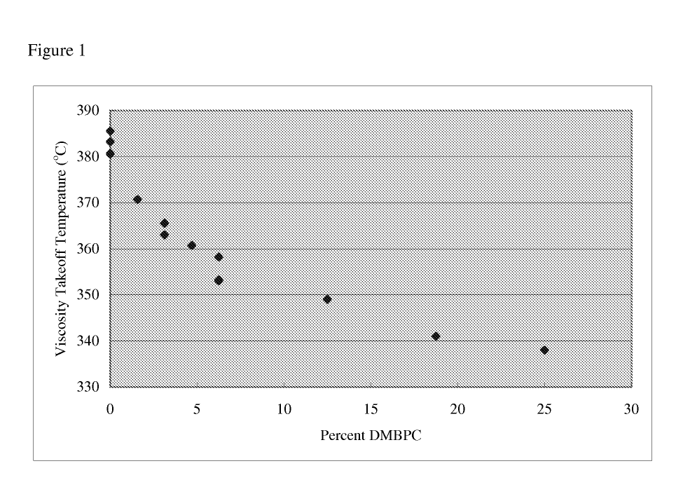

FIG. 1 shows the viscosity takeoff temperature vs. the percent DMBPC copolymer in the composition. As the temperature increases in the rheology test, the viscosity drops until it reaches a minimum value. The temperature of the material at the minimum value is referred to the viscosity takeoff temperature. After passing the minimum temperature, the viscosity sharply begins to increase. The minimum temperature is dependent on the amount of DMBPC copolymer in the composition. At 0% DMBPC copolymer (100% aromatic polycarbonate), the viscosity take-off temperature is about 380 to 385° C. As the percentage of DMBPC is increased, the take-off temperature decreases until about 338° C. for 25% DMBPC (or 100% of PC-5, the 25% DMBPC copolymer). This is important because the take-off temperature is related to the crosslinking temperature. At lower temperatures, the crosslinking reaction is triggered sooner, thereby increasing the viscosity and improving the melt strength. With improved melt strength, the composition (and molded articles) have better flame retardant properties, such as less or no dripping, which means that UL94 V0 rating can be achieved in thin walled samples.

Additional samples were produced using the components in Table 1, and tested according to the test methods previously described. The sample formulations are shown in Table 8 and test results are shown in Table 9 below.

TABLE 8

| COMPONENTS | Units | 25 | 26 | 27 | 28 | 29 | 30 | 31 | 32 | 33 | 34 | 35 |
|---|---|---|---|---|---|---|---|---|---|---|---|---|
| PC-4 | % | 100 | 100 | 100 | 100 | 100 | 100 | 0 | 0 | 0 | 0 | 0 |
| PC-6 | % | 0 | 0 | 0 | 0 | 0 | 0 | 100 | 100 | 100 | 100 | 100 |
| FR-1 | % | 0.08 | 0.08 | 0.08 | 0.12 | 0.12 | 0.10 | 0.08 | 0.08 | 0.12 | 0.12 | 0.10 |
| TSAN | % | 0.5 | 0.4 | 0.2 | 0.4 | 0.2 | 0.3 | 0.5 | 0.4 | 0.4 | 0.2 | 0.3 |
| Others* | % | 0.32 | 0.32 | 0.32 | 0.32 | 0.32 | 0.32 | 0.32 | 0.32 | 0.32 | 0.32 | 0.32 |

*An additive package comprising 0.05 wt. % antioxidant (Irgaphos ™ 168) and 0.27 wt % mold release agent (based on 100% by weight of the total composition) was also added to all samples.

TABLE 9

| PHYSICAL | | | | | | | | | | | | |
|---|---|---|---|---|---|---|---|---|---|---|---|---|
| PROPERTIES | | 25 | 26 | 27 | 28 | 29 | 30 | 31 | 32** | 33** | 34** | 35** |
| Pencil Hardness | — | H | H | H | H | H | H | 2B | 2B | 2B | 2B | 2B |
| Melt Flow | cm³/10 min. | 14.2 | 14.5 | 14.1 | 14.1 | 14.4 | 14.2 | 19.7 | 20.4 | 20.6 | 20.6 | 20.5 |
| p(FTP) at 2.0 mm | — | NA | 0.644 | 0.258 | 0.989 | 0.997 | 0.992 | 0.999 | 0.999 | 0.03 | 0.988 | 0.978 |
| Flaming drips | sec | NA | 0 | 2 in 10 | 0 | 0 | 0 | 0 | 0 | 4 in 10 | 0 | 0 |
| p(FTP) at 1.5 mm | — | NA | 0.857 | 0 | 0.983 | 0.03 | 0.984 | 0.998 | 0.489 | 0 | 0.131 | 0.1 |
| FOT1 at 1.5 mm* | sec | NA | 0 | 9 in 10 | 0 | 4 in 10 | 0 | 0 | 1 in 10 | 6 in 10 | 1 in 10 | 3 in 10 |

NA—not available.
*When listed as 5 in 10, it means that 5 of the 10 bars dripped, 2 in 10 means that 2 of the 10 bars dripped, etc.
**All samples without DMBPC copolymer (32 to 35) had some bars that dripped at 1.5 mm.

The above results illustrate that compositions made with the DMBPC copolymer, the flame retardant and the anti-dripping agent exhibited better scratch resistance and flame performance than the compositions without the DMBPC copolymer. Additionally, all samples without the DMBPC copolymer had some of the test bars that dripped during the V0 at 1.5 mm flammability testing and the drips ignited the cotton when the formulations has less then 0.5 wt. % anti-dripping agent. The robust UL94 V0 rating at 1.5 mm could still be achieved in the compositions having the DMBPC copolymer combined with an anti-dripping agent at the lower level of 0.3 wt. %.

As used herein, the terms “first,” “second,” and the like do not denote any order or importance, but rather are used to distinguish one element from another, and the terms “the”, “a” and “an” do not denote a limitation of quantity, but rather denote the presence of at least one of the referenced item. All ranges disclosed herein for the same properties or amounts are inclusive of the endpoints, and each of the endpoints is independently combinable. All cited patents, patent applications, and other references are incorporated herein by reference in their entirety.

The modifier “about” used in connection with a quantity is inclusive of the stated value and has the meaning dictated by the context (e.g., includes the degree of error associated with measurement of the particular quantity).

“Optional” or “optionally” means that the subsequently described event or circumstance may or may not occur, or that the subsequently identified material may or may not be present, and that the description includes instances where the event or circumstance occurs or where the material is present, and instances where the event or circumstance does not occur or the material is not present.

While the invention has been described with reference to a preferred embodiment, it will be understood by those skilled in the art that various changes may be made and equivalents may be substituted for elements thereof without departing from the scope of the invention. In addition, many modifications may be made to adapt a particular situation or material to the teachings of the invention without departing from essential scope thereof. Therefore, it is intended that the invention not be limited to the particular embodiment disclosed as the best mode contemplated for carrying out this invention, but that the invention will include all embodiments falling within the scope of the appended claims.

1. A thermoplastic composition comprising in combination
a dialkyl bisphenol polycarbonate homopolymer or copolymer comprising repeat carbonate units having the following structure; 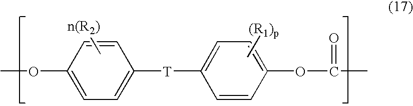
wherein R₁ and R₂ are independently at each occurrence a C₁-C₄ alkyl, n and p are each an integer having a value of 1 to 4, and T is selected from the group consisting of C₅-C₁₀ cycloalkanes attached to the aryl groups at one or two carbons, C₁-C5 alkyl groups, C₆-C₁₃ aryl groups, and C₇-C₁₂ aryl alkyl groups;
an aromatic polycarbonate;
and a flame retardant;
wherein the composition is capable of achieving a p(FTP) of at least 0.90 at a thickness of 3.0 mm.

2. The thermoplastic composition of claim 1, wherein the polycarbonate homopolymer or copolymer comprising repeat carbonate units of formula (17) comprise a dialkyl bisphenol polycarbonate copolymer comprising repeat carbonate units having the following structure 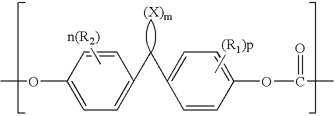
wherein R₁ and R₂ are independently selected from the group consisting of C₁ to C₆ alkyl; X represents CH₂; m is an integer from 4 to 7; n is an integer from 1 to 4; and p is an integer from 1 to 4, with the proviso that at least one of R₁ or R₂ is in the 3 or 3′ position.

3. The thermoplastic composition of claim 2, wherein amount of repeat carbonate units of formula (17) in the composition is at least 5 wt. %.

4. The thermoplastic composition of claim 2, wherein the repeat units of the dialkyl bisphenol polycarbonate copolymer are derived from the structure

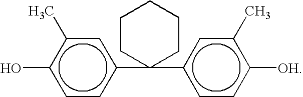

5. The thermoplastic composition of claim 1, wherein the flame retardant is a salt of a C₁₋₁₆ alkyl sulfonate.

6. The thermoplastic composition of claim 1, wherein the composition is capable of achieving a p(FTP) of at least 0.90 at a thickness of 2.0 mm.

7. The thermoplastic composition of claim 1, wherein a molded article consisting of the thermoplastic composition has a haze value of 2.0% or less when measured according to ASTM D1003-00 on a 3.2 mm thick plaque.

8. The thermoplastic composition of claim 7, wherein a molded article consisting of the thermoplastic composition has a haze value of 1.0% or less when measured according to ASTM D1003-00 on a 3.2 mm thick plaque.

9. The thermoplastic composition of claim 1, wherein a molded article consisting of the thermoplastic composition has a transmission value of at least 85.0% when measured according to ASTM D1003-00 on a 3.2 mm thick plaque.

10. An article comprising the thermoplastic composition of claim 1.

11. The article of claim 10, wherein the article has a scratch resistance of HB or harder when measured according to the ASTM D3363-92a Pencil Hardness Test.

12. A thermoplastic composition comprising in combination
a DMBPC homopolymer or copolymer having repeat units derived from the structure 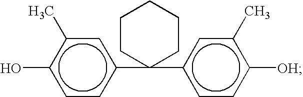
an aromatic polycarbonate; and
a flame retardant;
wherein the composition is capable of achieving a p(FTP) of at least 0.90 at a thickness of 3.0 mm.

13. The thermoplastic composition of claim 12, wherein a molded article consisting of the thermoplastic composition has a haze value of 2.0% or less when measured according to ASTM D1003-00 on a 3.2 mm thick plaque.

14. A thermoplastic composition comprising in combination
a dialkyl bisphenol polycarbonate homopolymer or copolymer comprising repeat carbonate units having the following structure; 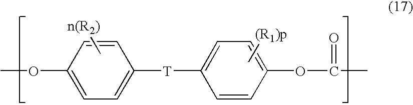
wherein R₁ and R₂ are independently at each occurrence a C₁-C₄ alkyl, n and p are each an integer having a value of 1 to 4, and T is selected from the group consisting of C₅-C₁₀ cycloalkanes attached to the aryl groups at one or two carbons, C₁-C5 alkyl groups, C₆-C₁₃ aryl groups, and C₇-C₁₂ aryl alkyl groups;
a flame retardant;
and an anti-dripping agent,
wherein the composition is capable of achieving a p(FTP) of at least 0.90 at a thickness of 2.0 mm.

15. The thermoplastic composition of claim 14, wherein the polycarbonate homopolymer or copolymer comprising repeat carbonate units of formula (17) comprise a dialkyl bisphenol polycarbonate copolymer comprising repeat carbonate units having the following structure 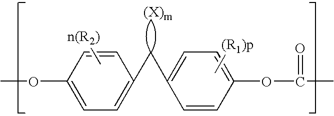
wherein R₁ and R₂ are independently selected from the group consisting of C₁ to C₆ alkyl; X represents CH₂; m is an integer from 4 to 7; n is an integer from 1 to 4; and p is an integer from 1 to 4, with the proviso that at least one of R₁ or R₂ is in the 3 or 3′ position.

16. The thermoplastic composition of claim 14, wherein amount of repeat carbonate units of formula (17) in the composition is at least 5 wt. %.

17. The thermoplastic composition of claim 14, wherein the repeat units of the dialkyl bisphenol polycarbonate copolymer are derived from the structure

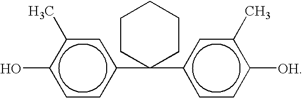

18. The thermoplastic composition of claim 14, flame retardant is a salt of a C₁₋₁₆ alkyl sulfonate.

19. The thermoplastic composition of claim 14, wherein the composition is capable of achieving a p(FTP) of at least 0.90 at a thickness of 1.5 mm.

20. The thermoplastic composition of claim 14, further comprising a second polycarbonate.

21. An article comprising the thermoplastic composition of claim 14.

22. The article of claim 21, wherein the article has a scratch resistance of HB or harder when measured according to the ASTM D3363-92a Pencil Hardness Test.

23. A thermoplastic composition comprising in combination
a DMBPC homopolymer or copolymer having repeat units derived from the structure 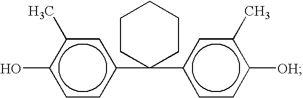
a flame retardant;
and an anti-dripping agent,
wherein the composition is capable of achieving a p(FTP) of at least 0.90 at a thickness of 2.0 mm.

24. The thermoplastic composition of claim 23, wherein the composition is capable of achieving a p(FTP) of at least 0.90 at a thickness of 1.5 mm.

25. The thermoplastic composition of claim 20, further comprising a second polycarbonate.
